(19) United States
(12) Patent Application Publication
(10) Pub. No.: US 2021/0268771 A1
(43) Pub. Date: Sep. 2, 2021

(54) RESIN METAL COMPOSITE BODY AND METHOD FOR PRODUCING SAME

(71) Applicant: IDEMITSU KOSAN CO.,LTD., Tokyo (JP)

(72) Inventors: Naoto OKUBO, Chiba-shi, Chiba (JP); Shinichi MIURA, Ichihara-shi, Chiba (JP); Takaaki UCHIDA, Chiba-shi, Chiba (JP); Hideaki YAMAGUCHI, Chiba-shi, Chiba (JP)

(73) Assignee: IDEMITSU KOSAN CO.,LTD., Tokyo (JP)

(21) Appl. No.: 17/255,957

(22) PCT Filed: Jun. 27, 2019
(86) PCT No.: PCT/JP2019/025740

§ 371 Date: Dec. 23, 2020

(30) Foreign Application Priority Data
Jun. 29, 2018 (JP) 2018-125557

(51) Int. Cl. B32B 15/09; B32B 15/20; B32B 27/36; B32B 27/20; B29C 45/14; B29C 45/00; C08L 25/06; C08L 67/02

(52) U.S. Cl. CPC B32B 15/09; B32B 15/20; B32B 27/36; B32B 27/20; B29C 45/14; B29C 45/0053; B29K 2509/08; C08L 67/02; B32B 2307/54; B32B 2307/558; B32B 2457/00; B32B 2264/101; B29C 2045/0079; C08L 25/06

(57) ABSTRACT

A resin metal composite body including a resin member containing a resin molding material containing a resin mixture (a1) and an inorganic filler (a2), and a metal member, and a test specimen of the resin mixture (a1) has a stress-strain curve in a tensile test according to ISO 527-1,2:2012 having a yield point, and a tensile yield stress of 25 MPa or more.

### TECHNICAL FIELD

The present invention relates to a resin metal composite body and a method for producing the same.

### BACKGROUND ART

A technique for integrating a metal and a resin, which are different materials, is being developed mainly in the fields of electronic and electric machines, automobiles, and electric home appliances. In particular, in the fields of electronic equipments, information and communications instruments, such as computers and mobile phones, are strongly demanded to have a reduced size, a reduced weight, and an increased speed, associated with the fast growth of the communication information amount, and a low dielectric constant resin metal composite body capable of addressing the demand is being desired. In the field of information and communication instruments, the use of the high frequency bands, such as the microwave and millimeter wave bands, proceeds due to the decrease of the usable wavelength bands, and the CPU clock frequency is becoming a high frequency reaching the gigahertz band. In the use as a chassis of an information and communication instrument, high impact strength capable of withstanding practical use is also demanded.

For the reduction of the size and the weight of the communication instrument capable of being used in the high frequency band, it is necessary to develop a resin metal composite body including a resin member having a low dissipation factor and a low dielectric constant, which does not delay the transmission rate of signals and does not decrease the signal intensity.

PTL 1 describes a resin composition for insert molding on a metal member, and describes that excellent impact resistance and low dielectric characteristics can be obtained. PTL 1 intends to increase the bonding strength between the metal member and the resin member, and evaluates the shear bonding strength.

### CITATION LIST

### Patent Literature

PTL 1: JP 2014-218076 A

### SUMMARY OF INVENTION

### Technical Problem

As described above, PTL 1 designs and evaluates the resin composition having high bonding strength in the application of a push off force, i.e., a shear stress, from the metal member to the bonding surface to the resin member, as the “bonding strength”. In the test applying a shear stress, a stress is applied uniformly to the entire bonding surface for evaluating the bonding strength.

However, in the situation for practical use of a resin metal composite body as a chassis or the like of an information and communication instrument, there are frequently cases where fracture, e.g., cleavage and exfoliation, occurs due to a stress that is unevenly applied to one side or an edge of the bonding surface.

### Solution to Problem

The present inventors have investigated to provide a resin metal composite body that has a bonding portion that is hard to undergo fracture, e.g., cleavage and exfoliation, on uneven application of a stress to one side or an edge of the bonding surface, and is capable of being used in the high frequency band. As a result, it has been found that the problem can be solved by a resin member that satisfies a particular requirement.

The present invention relates to the following items [1] to [14].

[1] A resin metal composite body including a resin member containing a resin molding material containing a resin mixture (a1) and an inorganic filler (a2), and a metal member, a test specimen of the resin mixture (a1) having a stress-strain curve in a tensile test according to ISO 527-1,2:2012 having a yield point, and a tensile yield stress of 25 MPa or more.

[2] The resin metal composite body according to the item [1], wherein the test specimen of the resin mixture (a1) has a nominal tensile fracture strain of 2.5% or more in a tensile test according to ISO 527-1,2:2012.

[3] The resin metal composite body according to the item [1] or [2], wherein a test specimen of 20 mm×5 mm×0.8 mm in thickness of the resin mixture (a1) has a loss tangent (tan δ) of solid viscoelasticity of 0.0200 or more measured under condition of a frequency of 1 Hz and around room temperature according to ISO 6721-4:1994.

[4] The resin metal composite body according to any one of the items [1] to [3], wherein the resin mixture (a1) contains at least one kind selected from a sydliotactic polystyrene, a polyester, a polyphenylene sulfide, a polyamide, and a polyether ether ketone.

[5] The resin metal composite body according to any one of the items [1] to [4], wherein the resin molding material contains the inorganic filler (a2) in an amount of 13.0% by mass or more and 37.0% by mass or less based on the total of the resin mixture (a1) and the inorganic filler (a2) as 100% by mass.

[6] The resin metal composite body according to any one of the items [1] to [5], wherein the resin molding material contains a glass filler as the inorganic filler (a2).

[7] The resin metal composite body according to any one of the items [1] to [6], wherein the resin metal composite body is an insert molded body.

[8] The resin metal composite body according to any one of the items [1] to [7], wherein the metal member is at least one kind selected from the group consisting of aluminum, stainless steel, copper, titanium, and alloys thereof.

[9] The resin metal composite body according to the item [8], wherein the metal member is aluminum or an aluminum alloy.

[10] The resin metal composite body according to any one of the items [1] to [9], wherein the metal member has a surface subjected to at least one selected from a chemical treatment and a physical treatment.

[11] The resin metal composite body according to any one of the items [1] to [10], wherein the resin metal composite body has pores having a diameter of 0.01 μm or more and 1,000 μm or less in at least a part of a surface of the metal member that is in contact with the resin member.

[12] A method for producing the resin metal composite body according to any one of the items [1] to [11], including injection molding the resin molding material on the metal member.

[13] The method for producing the resin metal composite body according to the item [12], wherein the method further includes subjecting the resin metal composite body obtained after injection molding, to cutting work using a working fluid.

[14] A method for producing a resin metal composite body, including subjecting the resin metal composite body according to any one of the items [1] to [11], to an anodization treatment and a pore sealing treatment.

### Advantageous Effects of Invention

According to the present invention, a resin metal composite body that has a bonding portion that is hard to undergo fracture, e.g., cleavage and exfoliation, on uneven application of a stress to one side or an edge of the bonding surface, and is capable of being used in the high frequency band, and a method for producing the same can be provided.

### BRIEF DESCRIPTION OF DRAWINGS

FIG. 1 is a schematic illustration of the resin member constituting the resin metal composite body of the present invention.

FIG. 2 is an illustration showing the specimen for evaluating the tensile bonding strength used in Examples and Comparative Examples.

FIG. 3 is a perspective view showing the metal resin composite body molded for the drop impact test in Examples and Comparative Examples.

FIG. 4 is a cross sectional view showing the metal resin composite body molded for the drop impact test in Examples and Comparative Examples on the line A-A in FIG. 3.

FIG. 5 is a rear view showing the specimen for the drop impact test used in Examples and Comparative Examples.

FIG. 6 is a front view showing the specimen for the drop impact test used in Examples and Comparative Examples.

FIG. 7 is a schematic illustration showing the structure of the specimen for the drop impact test used in Examples and Comparative Examples.

FIG. 8 is a side view showing the specimen for the drop impact test used in Examples and Comparative Examples.

### DESCRIPTION OF EMBODIMENTS

As a result of the earnest investigations by the present inventors, it has been found that in view of the fact that fracture, e.g., cleavage and exfoliation, of a metal composite body occurs at the interface between the metal member and the resin member on the assumption of the situation for practical use of the metal composite body, a resin metal composite body excellent in bonding strength can be obtained by imparting particular strength to the resin member that exists in the vicinity of the interface. The present invention will be described in detail below.

In the description herein, the expression “XX to YY” means “XX or more and YY or less”. In the description herein, the preferred embodiments may be arbitrarily employed, and a combination of the preferred embodiments may be further preferred.

The resin metal composite body of the present invention includes a resin member containing a resin molding material containing a resin mixture (a1) and an inorganic filler (a2), and a metal member, and a test specimen of the resin mixture (a1) has a stress-strain curve having a yield point in a tensile test according to ISO 527-1,2:2012, and a tensile yield stress of 25 MPa or more.

### 1. Resin Member

The resin member constituting the metal composite body of the present invention contains a resin molding material containing a resin mixture (a1) containing a resin as a major component, and an inorganic filler (a2). The expression “as a major component” means that the content of at least one kind selected from the following resins (1) to (5) is 60% by mass or more in the resin mixture (a1).

<Resin Mixture (a1)>

The resin mixture (a1) preferably contains at least one kind selected from a sydliotactic polystyrene, a polyester, a polyphenylene sulfide, a polyamide, and a polyether ether ketone, and preferably contains the resins as a major component. Among these, a sydliotactic polystyrene, a polyphenylene sulfide, a polyester, and a polyamide are more preferably used. The resins will be described below.

### Resin (1): Syndiotactic Polystyrene

The sydliotactic polystyrene referred in the present invention means a styrene-based resin having a highly sydliotactic structure (which may be hereinafter referred to as SPS). In the description herein, the term “syndiotactic” means a high proportion of the phenyl rings of the styrene units adjacent to each other that are alternately arranged with respect to the plane constituted by the main chain of the polymer block (which may be hereinafter referred to as sydliotacticity).

The tacticity can be quantitatively identified by the nuclear magnetic resonance method using isotope carbon (i.e., the ¹³C-NMR method). The existing proportions of continuous plural constitutional units, for example, continuous two monomer units as a diad, continuous three monomer units as a triad, and continuous five monomer units as a pentad, can be quantitatively identified by the ¹³C-NMR method.

In the present invention, the “styrene-based resin having a highly sydliotactic structure” means a polystyrene, a poly(hydrocarbon-substituted styrene), a poly(halostyrene), a poly(haloalkylstyrene), a poly(alkoxystyrene), a poly(vinyl benzoate ester), a hydrogenated polymer or a mixture thereof, and a copolymer having these as a major component, each having a racemic diad (r) fraction of generally 75% by mol or more, and preferably 85% by mol or more, or having a racemic pentad (rrrr) fraction of generally 30% by mol or more, and preferably 50% by mol or more.

Examples of the poly(hydrocarbon-substituted styrene) include poly(methylstyrene), poly(ethylstyrene), poly(isopropylstyrene), poly(tert-butylstyrene), poly(phenyl)styrene, poly(vinylnaphthalene), and poly(vinylstyrene). Examples of the poly(halostyrene) include poly(chlorostyrene), poly(bromostyrene), and poly(fluorostyrene), and examples of the poly(haloalkylstyrene) include poly(chloromethylstyrene). Examples of the poly(alkoxystyrene) include poly(methoxystyrene) and poly(ethoxystyrene).

Examples of the comonomer component of the copolymer containing these constitutional units include the monomers of the aforementioned styrene-based polymers, and also include olefin monomers, such as ethylene, propylene, butene, hexene, and octene; diene monomers, such as butadiene and isoprene; cyclic olefin monomers; cyclic diene monomers; and polar vinyl monomers, such as methyl methacrylate, maleic anhydride, and acrylonitrile.

Particularly preferred examples of the aforementioned styrene-based resins include polystyrene, poly(p-methylstyrene), poly(m-methylstyrene), poly(p-tert-butylstyrene), poly(p-chlorostyrene), poly(m-chlorostyrene), and poly(p-fluorostyrene).

Examples thereof also include a copolymer of styrene and p-methylstyrene, a copolymer of styrene and p-tert-butylstyrene, and a copolymer of styrene and divinylbenzene.

The molecular weight of the SPS is not particularly limited, and the weight average molecular weight thereof is preferably 1×10⁴ or more and 1×10⁶ or less, more preferably 50,000 or more and 500,000 or less, and further preferably 50,000 or more and 300,000 or less, from the standpoint of the flowability of the resin in molding and the mechanical properties of the resulting molded body. In the case where the weight average molecular weight is 1×10⁴ or more, a molded body having sufficient mechanical properties can be obtained. In the case where the weight average molecular weight is 1×10⁶ or less, there may be no problem in the flowability of the resin in molding.

The melt flow rate (MFR) of the SPS measured under condition of a temperature of 300° C. and a load of 1.2 kgf is preferably 2 g/10 min or more, and more preferably 4 g/10 min or more. In the case where the MFR is in the range, there may be no problem in the flowability of the resin in molding. In the case where the MFR is 50 g/10 min or less, and preferably 30 g/10 min or less, a molded body having sufficient mechanical properties can be obtained.

The SPS of this type can be produced, for example, with reference to the technique described in JP 62-187708 A. Specifically, the SPS can be produced by polymerizing a styrene-based monomer (i.e., a monomer corresponding to the aforementioned styrene-based polymer) with a condensation product of a titanium compound, water, and a trialkyl aluminum as a catalyst in the presence of an inert hydrocarbon solvent or in the absence of a solvent. The poly(haloalkylstyrene) can be produced according to the method described in JP 1-146912 A, and the hydrogenated polymer thereof can be produced according to the method described in JP 1-178505 A.

### Resin (2): Polyester

The polyester is a thermoplastic resin that is preferably produced through polycondensation of a dicarboxylic acid compound and a dihydroxy compound, polycondensation of an oxycarboxylic acid compound, polycondensation of these compounds, or the like, and may be any of a homopolyester and a copolyester.

The dicarboxylic acid compound constituting the polyester is preferably an aromatic dicarboxylic acid or an ester-forming derivative thereof.

Examples of the aromatic dicarboxylic acid include terephthalic acid, isophthalic acid, orthophthalic acid, 1,5-naphthalenedicarboxylic acid, 2,5-naphthalene dicarboxylic acid, 2,6-naphthalenedicarboxylic acid, biphenyl-2,2′-dicarboxylic acid, biphenyl-3,3′-dicarboxylic acid, biphenyl-4,4′-dicarboxylic acid, diphenyl ether-4,4′-dicarboxylic acid, diphenylmethane-4,4′-dicarboxylic acid, diphenylsulfone-4,4′-dicarboxylic acid, diphenylisopropylidene-4,4′-dicarboxylic acid, 1,2-bis(phenoxy)ethane-4,4′-dicarboxylic acid, anthracene-2,5-dicarboxylic acid, anthracene-2,6-dicarboxylic acid, p-terphenylene-4,4′-dicarblxylic acid, and pyridine-2,5-dicarboxylic acid, and terephthalic acid is preferably used.

The aromatic dicarboxylic acid may be used as a mixture of two or more kinds thereof. It has been well known that in addition to the free acid, the ester-forming derivative thereof, such as a dimethyl ester thereof, may be used for the polycondensation reaction. A small amount of one or more kind of an aliphatic dicarboxylic acid, such as adipic acid, azelaic acid, dodecanedioic acid, and sebacic acid, and an alicyclic dicarboxylic acid, such as 1,2-cyclohexanedicarboxylic acid, 1,3-cyclohexanedicarboxylic acid, and 1,4-cyclohexanedicarboxylic acid, may be mixed and used with the aromatic dicarboxylic acid.

Examples of the dihydroxy compound constituting the polyester include an aliphatic diol, such as ethylene glycol, propylene glycol, butanediol, hexylene glycol, neopentyl glycol, 2-methylpropan-1,3-diol, diethylene glycol, and triethylene glycol, an alicyclic diol, such as cyclohexane-1,4-dimethanol, and a mixture thereof. A small amount of one or more kind of a long-chain diol having a molecular weight of 400 to 6,000, such as polyethylene glycol, poly-1,3-propylene glycol, and polytetramethylene glycol, may be copolymerized. An aromatic diol, such as hydroquinone, resorcinol, naphthalenediol, dihydroxydiphenyl ether, and 2,2-bis(4-hydroxyphenyl)propane, may also be used.

In addition to the aforementioned bifunctional monomers, a trifunctional monomer, such as trimellitic acid, trimesic acid, pyromellitic acid, pentaerythritol, and trimethylolpropane, may be used for introducing a branched structure, and a monofunctional compound, such as a fatty acid, may be used for controlling the molecular weight.

The polyester used is generally a compound formed through polycondensation of mainly a dicarboxylic acid and a diol, i.e., a compound containing the polycondensation product in an amount of 50% by mass, and preferably 70% by mass, based on the total amount of the resin. The dicarboxylic acid is preferably an aromatic carboxylic acid, and the diol is preferably an aliphatic diol.

Among these, a polyalkylene terephthalate containing terephthalic acid in an amount of 95% by mol or more of the acid component and an aliphatic diol in an amount of 95% by mass or more of the alcohol component is preferred. A polybutylene terephthalate (which may be hereinafter abbreviated as PBT) formed of terephthalic acid and 1,4-butanediol is particularly preferred.

The polybutylene terephthalate may also be preferably a modified polybutylene terephthalate copolymerized with isophthalic acid, a dimer acid, a polyalkylene glycol, such as polytetramethylene glycol (PTMG), and the like, from the standpoint of the bonding strength of the resin metal composite body.

In the case where an isophthalic acid-copolymerized polybutylene terephthalate resin is used as the modified polybutylene terephthalate, the proportion of the isophthalic acid component occupied in the total carboxylic acid components is preferably 1 to 30% by mol, more preferably 2 to 20% by mol, and further preferably 3 to 15% by mol, in terms of carboxylic acid group. With the copolymerization ratio, there is a tendency of providing good balance among the bonding capability, the durability, the injection moldability, and the toughness, which is preferred.

In the case where a polyester ether copolymerized with polytetramethylene glycol is used as the modified polybutylene terephthalate, the proportion of the tetramethylene glycol component in the copolymer is preferably 3 to 40% by mass, more preferably 5 to 30% by mass, and further preferably 10 to 25% by mass. With the copolymerization ratio, there is a tendency of providing good balance between the bonding capability and the heat resistance, which is preferred.

In the case where a dimer acid-copolymerized polybutylene terephthalate is used as the modified polybutylene terephthalate, the proportion of the dimer acid component occupied in the total carboxylic acid components is preferably 0.5 to 30% by mol, more preferably 1 to 20% by mol, and further preferably 3 to 15% by mol, in terms of carboxylic acid group. With the copolymerization ratio, there is a tendency of providing good balance among the bonding capability, the long-term heat resistance, and the toughness, which is preferred.

The polyester preferably contains a polybutylene terephthalate and/or the aforementioned modified polybutylene terephthalate, and in this case, the content ratio of the modified polybutylene terephthalate is preferably 10% by mass or more, more preferably 20 to 90% by mass, further preferably 25 to 80% by mass, and particularly preferably 30 to 70% by mass, based on the total amount of the polybutylene terephthalate and the modified polybutylene terephthalate as 100% by mass. The content of the modified polybutylene terephthalate that is less than 10% by mass is not preferred since there is a tendency that the bonding strength of the resin metal composite body is decreased.

The intrinsic viscosity of the polyester is preferably 0.5 to 2 dL/g. The intrinsic viscosity is preferably 0.6 to 1.5 dL/g from the standpoint of the moldability and the mechanical characteristics. The use of the polyester having an intrinsic viscosity of less than 0.5 dL/g tends to provide the resin mixture (a1) that has low mechanical strength. The use thereof having an intrinsic viscosity exceeding 2 dL/g may deteriorate the flowability of the resin mixture (a1) to deteriorate the moldability thereof, and may decrease the bonding strength of the resulting resin metal composite body, in some cases.

The melt flow rate (MFR) of the polyester measured under condition of a temperature of 250° C. and a load of 2.16 kgf is preferably 5 g/10 min or more, more preferably 8 g/10 min or more, and further preferably 10 g/10 min. In the case where the MFR of the polyester is in the range, there may be no problem in the flowability of the resin mixture in molding. A molded body having sufficient mechanical properties can be obtained in the case where the MFR of the polyester is 20 g/10 min or less, or 15 g/10 min or less.

### Resin (3): Polyphenylene Sulfide

The polyphenylene sulfide (which may be hereinafter abbreviated as PPS) used may be a polymer having a repeating unit represented by the general formula: -(Ph-S)— (wherein Ph represents a phenylene group, and S represents sulfur).

Assuming that the repeating unit (Ph-S) is one mol (unit mol), the polyphenylene sulfide that can be used in the resin mixture (a1) of the present invention is preferably a polymer containing the repeating unit in an amount of generally 50% by mol or more, preferably 70% by mol or more, and more preferably 90% by mol or more.

Examples of the phenylene group include p-phenylene, m-phenylene, o-phenylene, an alkyl-substituted phenylene (preferably an alkyl group having 1 to 6 carbon atoms), phenyl-substituted phenylene, halogen-substituted phenylene, amino-substituted phenylene, amide-substituted phenylene, p,p′-diphenylene sulfone, p,p′-biphenylene, p,p′-biphenylene ether, p,p′-biphenylene carbonyl, and naphthalene. The polyphenylene sulfide containing the phenylene group may be a homopolymer formed of the same repeating unit, a copolymer formed of two or more kinds of different phenylene groups, or a mixture thereof.

In the polyphenylene sulfide, a polyphenylene sulfide that contains p-phenylene sulfide as a major constitutional component of the repeating unit is particularly preferred since it is excellent in workability and is easily available industrially. In addition, a polyphenylene ketone sulfide, polyphenylene ketone ketone sulfide, and the like may also be used. Specific examples of the copolymer include a random or block copolymer having a repeating unit of p-phenylene sulfide and a repeating unit of m-phenylene sulfide, a random or block copolymer having a repeating unit of phenylene sulfide and a repeating unit of phenylene ketone sulfide, a random or block copolymer having a repeating unit of phenylene sulfide and a repeating unit of phenylene ketone ketone sulfide, and a random or block copolymer having a repeating unit of phenylene sulfide and a repeating unit of phenylene sulfone sulfide. The polyphenylene sulfide may be a crystalline polymer.

The polyphenylene sulfide may be produced by a known method, and for example, produced by the method described in WO 2008/038512. The polyphenylene sulfide may be heated in the air to increase the molecular weight thereof, and may be chemically modified with a compound, such as an acid anhydride.

The melt viscosity at 300° C. (shear rate: 1,216 per second) of the polyphenylene sulfide is preferably 100 to 1,500 poise, and more preferably 350 to 700 poise.

### Resin (4): Polyamide

The polyamide used may be a known arbitrary polyamide. Examples of the suitable polyamide include polyamide-4, polyamide-6, polyamide-6,6; polyamide-3,4; polyamide-12; polyamide-11; polyamide-6, 10; a polyamide obtained from terephthalic acid and 4,4′-diaminohexylmethane, a polyamide obtained from azelaic acid, adipic acid, and 2,2-bis(p-cyclohexyl)propane, and a polyamide obtained from adipic acid and m-xylylenediamine.

An aromatic polyamide is a polyamide polymer containing an amide bond as a repeating unit having an aromatic ring in the main chain, and may be appropriately selected from a polymer obtained through reaction of an aromatic diamine component and a dicarboxylic acid component by the ordinary method and a polymer obtained through reaction of a diamine component and a dicarboxylic acid component having an aromatic ring by the ordinary method.

Examples of the aromatic diamine component used include a diamine compound having a benzene ring, such as 1,4-diaminobenzene, 1,3-diaminobenzene, 1,2-diaminobenzene, 2,4-diaminotoluene, 2,3-diaminotoluene, 2,5-diaminotoluene, 2,6-diaminotoluene, o-, m-, or p-xylyenediamine, o-, m-, or p-2,2′-diaminodiethylbenzene, 4,4′-diaminobiphenyl, 4,4′-diamiodiphenylmethane, 4,4′-diaminodiphenyl ether, 4,4′-diaminodiphenyl thioether, 4,4′-diaminodiphenyl ketone, and 4,4′-diaminiodiphenyl sulfone. The aromatic diamine component may be the diamine component having an aromatic ring alone, or may be a mixture with another diamine component, such as an aliphatic diamine component, as far as an aromatic ring is contained. The diamine compound having an aromatic ring may be used as a mixture of two or more kinds thereof.

Examples of the dicarboxylic acid component include an aliphatic dicarboxylic acid compound, such as glutaric acid, adipic acid, pimelic acid, suberic acid, azelaic acid, and sebacic acid, an aromatic dicarboxylic acid, such as phthalic acid, isophthalic acid, terephthalic acid, and naphthalenedicarboxylic acid, and esters and acid chlorides of these dicarboxylic acid compounds. These compounds may be used alone or as a combination of two or more kinds thereof.

An aromatic polyamide resin may also be obtained through polymerization of an ω-amino-ω′-carboxy compound having an aromatic ring, and examples of the ω-amino-ω′-carboxy compound having an aromatic ring include 4-aminophenylcarboxymethane, 1-(4-aminophenyl)-2-carboxyethane, 3-(4-aminophenyl)-1-carboxypropane, and p-(3-amino-3′-carboxy)dipropylbenzene.

Preferred examples of the aromatic polyamide include a polyamide derived from a diamine compound having a benzene ring and an aliphatic dicarboxylic acid compound, and more preferred examples thereof include a polyamide derived from xylylenediamine and adipic acid. The polyamide may be used alone or as a combination of two or more kinds thereof.

The resin mixture (a1) contains a resin selected from at least one kind selected from the SPS as the resin (1), the polyester as the resin (2), the polyphenylene sulfide as the resin (3), the polyamide as the resin (4), and the polyether ether ketone as the resin (5), as a major component. The expression “as a major component” means that the content of at least one kind selected from the resins (1) to (5) is 60% by mass or more in the resin mixture (a1). The content of the resin as a major component is more preferably 62% by mass or more, more preferably 65% by mass or more, and further preferably 70% by mass or more. In the case where plural kinds of the resins (1) to (5) are used as the resin as a major component, the total amount thereof is applied to the aforementioned range.

### <Additional Components>

The resin mixture (a1) in the resin molding material constituting the resin component portion of the resin metal composite body of the present invention may further contain a component other than the resin as a major component depending on necessity. The component will be described in detail below. In the description herein, the resin as a major component, a rubber-like elastomer (i.e., the following component (1)), and an acid-modified polyphenylene ether (i.e., the following component (2)) in the resin mixture (a1) each are referred to as a “resin component in the resin mixture (a1)”.

### Component (1): Rubber-Like Elastomer

The resin mixture (a1) may further contain a rubber-like elastomer. The rubber-like elastomer is preferably contained since it imparts elasticity and viscosity to the resin member, and thereby can impart significantly high durability to the resin metal composite body. Specifically, the rubber-like elastomer imparts elasticity and viscosity to the resin member, so that the resin metal composite body exhibits high vibration and impact absorbability and simultaneously resolves the strain through dispersion of the internal pressure, and as a result, high bonding strength can be achieved at the bonding interface between the metal member and the resin member.

Examples of the rubber-like elastomer include natural rubber, polybutadiene rubber, polyisoprene, polyisobutylene rubber, neoprene rubber, polysulfide rubber, thiol rubber, acrylic rubber, urethane rubber, silicone rubber, epichlorohydrin rubber, a styrene-butadiene block copolymer, a styrene-butadiene-styrene block copolymer, a hydrogenated styrene-butadiene-styrene block copolymer, a styrene-isoprene block copolymer, ethylene-propylene rubber, ethylene-propylene-diene rubber, rubber obtained modifying these kinds of rubber, and a ethylene-glycidyl methacrylate copolymer, and also include at least one kind of a styrene-based polymer selected from the group consisting of a styrene-butadiene block copolymer, a styrene-isoprene block copolymer, a styrene-butadiene-styrene block copolymer, a styrene-isoprene-styrene block copolymer, a styrene-ethylene-propylene-styrene block copolymer, a styrene-ethylene-ethylene-propylene-styrene block copolymer, a styrene-ethylene-butylene-styrene block copolymer, a styrene-isoprene-butadiene-styrene block copolymer, and hydrogenated products of these materials. Among these, at least one kind of a styrene-based polymer selected from a styrene-ethylene-butylene-styrene block copolymer, a styrene-butadiene block copolymer, an ethylene-glycidyl methacrylate copolymer, and a styrene-butadiene-styrene block copolymer is preferred, and a styrene-ethylene-butylene-styrene block copolymer is more preferred. Two or more kinds of styrene-ethylene-butylene-styrene block copolymers are further preferably used. The use of two or more kinds of styrene-ethylene-butylene-styrene block copolymers can enhance the controllable ranges of the molecular weight and the styrene content, resulting in the resin member that is excellent in toughness and strength within the balance of the resin mixture (a1).

The molecular weight of the rubber-like elastomer correlates to the MFR thereof, and therefore can be evaluated indirectly by the MFR measured according to ISO 1133-1:2011. In the present invention, the MFR of the rubber-like elastomer under measurement condition of a temperature of 230° C. and a load of 2.16 kgf is preferably 0.0 (no flow) to 10.0 g/10 min. With the MFR of 10.0 g/10 min or less, sufficient strength can be obtained. With the MFR of 0.0 g/10 min or more, the dispersibility of the rubber-like elastomer in the resin mixture can be favorably retained.

In the case where the rubber-like elastomer contains a styrene-based polymer, the styrene content thereof is preferably 25% by mass or more and 35% by mass or less. With the styrene content of 35% by mass or less, sufficient toughness can be imparted. With the styrene content of 25% by mass or more, excellent compatibility with the styrene-based resin having a syndiotactic structure can be obtained.

The content of the rubber-like elastomer in the resin mixture (a1) is preferably 12.0% by mass or more and 37.0% by mass or less. With the content of the rubber-like elastomer of 12.0% by mass or more, high viscosity and high elasticity can be simultaneously achieved. With the content of the rubber-like elastomer of 37.0% by mass or less, plastic deformation due to strain of the resin member can be suppressed.

The content of the rubber-like elastomer in the resin mixture (a1) is more preferably 15% by mass or more, further preferably 18% by mass or more, and still further preferably 20% by mass or more, and is more preferably 35% by mass or less, further preferably 33% by mass or less, and still further preferably 30% by mass or less. In the case where plural kinds of the rubber-like elastomers are contained, the total amount thereof is applied to the aforementioned range.

### Component (2): Acid-Modified Polyphenylene Ether

The acid-modified polyphenylene ether can enhance the interface strength to the inorganic filler (a2) described later, particularly to a glass filler, and thereby can enhance the strength of the resin member.

The acid-modified polyphenylene ether is a compound obtained through acid modification of a polyphenylene ether. The polyphenylene ether used may be a known compound, and preferred examples thereof include poly(2,3-dimethyl-6-ethyl-1,4-phenylene ether), poly(2-methyl-6-chloromethyl-1,4-phenylene ether), poly(2-methyl-6-hydroxyethyl-1,4-phenylene ether), poly(2-methyl-6-n-butyl-1,4-phenylene ether), poly(2-ethyl-6-isopropyl-1,4-phenylene ether), poly(2-ethyl-6-n-propyl-1,4-phenylene ether), poly(2,3,6-trimethyl-1,4-phenylene ether), poly(2-(4′-methylphenyl)-1,4-phenylene ether), poly(2-bromo-6-phenyl-1,4-phenylene ether), poly(2-methyl-6-phenyl-1,4-phenylene ether), poly(2-phenyl-1,4-phenylene ether), poly(2-chloro-1,4-phenylene ether), poly(2-methyl-1,4-phenylene ether), poly(2-chloro-6-ethyl-1,4-phenylene ether), poly(2-chloro-6-bromo-1,4-phenylene ether), poly(2,6-di-n-propyl-1,4-phenylene ether), poly(2-methyl-6-isopropyl-1,4-phenylene ether), poly(2-chloro-6-methyl-1,4-phenylene ether), poly(2-methyl-6-ethyl-1,4-phenylene ether), poly(2,6-dibromo-1,4-phenylene ether), poly(2,6-dichloro-1,4-phenylene ether), poly(2,6-diethyl-1,4-phenylene ether), and poly(2,6-dimethyl-1,4-phenylene ether). In addition, the compounds described in U.S. Pat. Nos. 3,306,874, 3,306,875, 3,257,357, and 3,257,358 may also be used.

The polyphenylene ether is generally prepared through oxidation coupling reaction forming a homopolymer or a copolymer in the presence of a copper-amine complex and a substituted phenol having one or more substituent. The copper-amine complex used herein may be a copper-amine complex derived from a primary, secondary, or tertiary amine.

The acid-modified polyphenylene ether (C) used is preferably a maleic anhydride-modified or fumaric acid-modified polyphenylene ether.

Examples of the acid used for the acid modification include maleic anhydride and a derivative thereof, and fumaric acid and a derivative thereof. The derivative of maleic anhydride is a compound that has an ethylenic double bond and a polar group, such as a carboxy group or an acid anhydride group, in one molecule. Specific examples thereof include maleic acid, a maleate monoester, a maleate diester, a maleimide and an N-substituted compound thereof (such as an N-substituted maleimide, a maleic acid monoamide, and a maleic acid diamide), an ammonium salt of maleic acid, a metal salt of maleic acid, acrylic acid, methacrylic acid, a methacrylate ester, and glycidyl methacrylate. Specific examples of the derivative of the fumaric acid include a fumarate diester, a metal salt of fumaric acid, an ammonium salt of fumaric acid, and a halide of fumaric acid. Among these, fumaric acid and maleic anhydride are particularly preferred.

The content of the acid-modified polyphenylene ether in the resin mixture (a1) is preferably 0.1% by mass or more and 3.9% by mass or less. With the content thereof of 0.1% by mass or more, sufficient strength can be obtained at the interface between the resin as a major component and the inorganic filler, resulting in excellent strength of the resin member. The content thereof of 3.9% by mass or less is preferred since the color tone of the resin member may not be adversely affected, and the resin member can have a high degree of freedom in coloring.

The amount of the acid-modified polyphenylene ether mixed in the resin mixture (a1) is more preferably 1.0% by mass or more, and further preferably 1.5% by mass or more, and is more preferably 3.0% by mass or less, and further preferably 2.5% by mass or less. The acid-modified polyphenylene ether may be used alone or as a combination of two or more kinds thereof.

Component (3): Antioxidant A known antioxidant may be used, but in the present invention, a phosphorus-based antioxidant is preferably not contained. The use of a phosphorus-based antioxidant is preferably avoided since phosphoric acid gas may be generated in molding and accelerates metal corrosion. The expression that “a phosphorus-based antioxidant is not contained” specifically means that the amount of a phosphorus-based antioxidant is 5,000 ppm by mass or less, more preferably 1,000 ppm by mass or less, further preferably 500 ppm by mass or less, and still further preferably 50 ppm by mass or less, in the resin component of the resin mixture (a1).

The antioxidant used is preferably a phenol-based antioxidant. Examples of the phenol-based antioxidant include triethylene glycol bis(3-(3-tert-butyl-5-methyl-4-hydroxyphenyl)propionate), 1,6-hexanediol bis(3-(3,5-di-tert-butyl-4-hydroxyphenyl)propionate), pentaerythryl tetrakis(3-(3,5-di-tert-butyl-4-hydroxyphenyl)propionate), octadecyl 3-(3,5-di-tert-butyl-4-hydroxyphenyl)propionate, 3,5-di-tert-butyl-4-hydroxybenzyl phosphonate diethyl ester, N,N′-hexamethylenebis(3,5-di-tert-butyl-4-hydroxyhydrocinnamamide), 1,3,5-trimethyl-2,4,6-tris(3,5-di-tert-butyl-4-hydroxybenzyl)benzene, and 3,9-bis(2-(3-(3-tert-butyl-4-hydroxy-5-methylphenyl)propynyloxy)-1,1-dimethylethyl)-2,4,8,10-tetraoxaspiro[5,5]undecane.

The antioxidant mixed can decrease the thermal decomposition in kneading and molding. The antioxidant may be used alone or as a combination of two or more kinds thereof.

The amount of the antioxidant added is preferably 0.05 part by mass or more, and more preferably 0.10 part by mass or more, and is preferably 0.50 part by mass or less, and more preferably 0.30 part by mass or less, per 100 parts by mass of the resin component in the resin mixture (a1). In the case where plural kinds of the antioxidants are contained, the total amount thereof is applied to the aforementioned range.

### Component (4): Nucleating Agent

A nucleating agent (crystallization nucleating agent) contained in the resin mixture (a1) can retain the appropriate crystallization rate in molding resin pellets, and the mass productivity of the pellets can be secured.

A known nucleating agent may be used, and examples thereof include a metal salt of a carboxylic acid, such as aluminum di(p-tert-butylbenzoate), a metal salt of phosphoric acid, such as sodium 2,2′-methylenebis(4,6-di-tert-butylphenyl)phosphate and sodium methylenebis(2,4-di-tert-butylphenol) acid phosphate, a phthalocyanine derivative, and a phosphate ester-based compound.

The nucleating agent may be used alone or as a combination of two or more kinds thereof.

The amount of the nucleating agent added is preferably 0.2 part by mass or more, and more preferably 0.5 part by mass or more, and is preferably 2.0 parts by mass or less, and more preferably 1.5 parts by mass or more, per 100 parts by mass of the resin component in the resin mixture (a1). With the amount thereof of 0.2 part by mass or more, the mass productivity of the pellets can be favorably retained, and with the content thereof of 2.0 parts by mass or less, the relative dielectric constant and the dissipation factor of the resin metal composite body are not adversely affected.

In molding the resin metal composite body of the present invention, a release agent may not be necessarily used since injection molding is performed with the metal member inserted into the mold for the injection molding, and therefore the release resistance applied to between the mold and the resin in releasing the resin from the mold becomes smaller than the case where injection molding is performed only with a resin (composition). A release agent is preferably not contained since the release agent tends to decrease the viscosity of the resin molding material, and brings about the possibility of generating gas in molding. In the case where the resin molding material constituting the resin member contains a release agent, the release agent exists in the vicinity of the interface between the resin member and the metal member to influence the bonding strength. Accordingly, the expression that “a release agent is not contained” specifically means that the amount of the release agent is 0.6% by mass or less based on the resin molding material (i.e., the total of the resin mixture (a1) and the inorganic filler (a2)) as 100% by mass. Examples of the release agent include polyethylene wax, a silicone oil, a long-chain carboxylic acid, and a metal salt of a long-chain carboxylic acid. Examples of the commercially available trade name thereof include SH-200-13000CS and SH-550 (produced by Dow Corning Toray Co., Ltd.), KF-53 (produced by Shin-Etsu Silicone Co., Ltd.), and Lico Wax OP (produced by Clariant Japan Co., Ltd.).

In the present invention, a neutralizing agent is also preferably not contained in the resin molding material. In the present invention, a phosphorus-based antioxidant, which forms an acid component, is preferably not contained as described above, and therefore there is only less necessity of a neutralizing agent. In addition, a neutralizing agent is not preferred since it also has a tendency of increasing the relative dielectric constant of the resin metal composite body. Specific examples of the neutralizing agent include at least one kind of a neutralizing agent selected from basic metal salts, particularly a compound containing calcium element, a compound containing aluminum element, and a compound containing magnesium element. The expression that “a neutralizing agent is not contained” specifically means that the amount of the neutralizing agent is 0.30% by mass or less based on the resin molding material (i.e., the total of the resin mixture (a1) and the inorganic filler (a2)) as 100% by mass.

<Inorganic Filler (a2)>

The inorganic filler includes a fibrous filler and a particulate or powder filler. Examples of the fibrous filler include a glass filler, carbon fibers, whiskers, and mica. Examples of the form thereof include a cloth form, a mat form, a cut bundle form, short fibers, a filament form, and whiskers, and the filler that is in a cut bundle form preferably has a length of 0.05 mm to 50 mm and a fiber diameter of 5 to 20 μm. Examples of the particulate or powder filler include talc, carbon black, graphite, titanium dioxide, silica, mica, calcium sulfate, calcium carbonate, barium carbonate, magnesium carbonate, magnesium sulfate, barium sulfate, an oxysulfate, tin oxide, alumina, kaolin, silicon carbide, metal powder, glass powder, glass flakes, and glass beads.

The inorganic filler is preferably a glass filler.

### <Glass Filler>

A glass filler is preferred since it can impart strength to the resin member and can decrease the molding shrinkage ratio of the resin in molding. In the resin metal composite body, the capability of decreasing the molding shrinkage ratio can decrease the residual stress at the interface between the resin member and the metal member, and the problems including exfoliation and deformation of the resin metal composite body can be suppressed. Furthermore, the glass filler contained can enhance the elastic modulus of the resin member. In the resin metal composite body, the stress concentration to the interface between the resin member and the metal member can be reduced with the elastic moduli of the members that are closer to each other, and therefore the increase of the elastic modulus of the resin member can enhance the drop impact characteristics of the resin metal composite body. The form of the glass filler is not particularly limited as described above, and various forms, such as a fibrous form, a particulate form, a plate form, and a powder form, may be used. Among these, a glass filer that is in a fibrous form having an elliptical (flat) cross sectional shape (i.e., flat glass fibers) is more preferably used from the standpoint of the molding shrinkage ratio and the bending elastic modulus in TD (transverse direction, which is the direction perpendicular to the flowing direction of the resin) of the resin member.

Specific examples thereof preferably used include glass powder, glass flakes, glass beads, glass filaments, glass fibers, glass roving, and glass mat. For enhancing the affinity to the resin, it is effective to subject the glass filler to a surface treatment. The surface treatment of the glass filler may be performed, for example, with a coupling agent, which may be arbitrarily selected from known materials, such as a silane coupling agent, e.g., an aminosilane series, an epoxysilane series, a vinylsilane series, and a methacrylsilane series, and a titanium coupling agent.

Among these, an aminosilane and an epoxysilane, such as γ-aminopropyltrimethoxysilane, N-ß-(aminoethyl)-γ-aminopropyltrimethoxysilane, γ-glycidoxypropyltrimethoxysilane, and ß-(3,4-epoxycyclohexyl)ethyltrimethoxysilane, and isopropyl tri(N-amidoethyl aminoethyl) titanate are preferably used as the surface treatment agent. The surface treatment method for the glass filler may be a known method and is not particularly limited.

Examples of the kind of glass include E glass, C glass, S glass, D glass, ECR glass, A glass, and AR glass. E glass or D glass is preferably used particularly for providing a low dielectric constant for the resin metal composite body. Examples of E glass include glass having a composition containing 52% by mass or more and 56% by mass or less of SiO₂, 12% by mass or more and 16% by mass or less of Al₂O₃, 15% by mass or more and 25% by mass or less of CaO, 0% by mass or more and 6% by mass or less of MgO, 5% by mass or more and 13% by mass or less of B₂O₃, and 0% by mass or more and 2% by mass or less in total of Na₂O and K₂O. Examples of D glass include glass having a composition containing 72% by mass or more and 76% by mass or less of SiO₂, 0% by mass or more and 5% by mass or less of Al₂O₃, 20% by mass or more and 25% by mass or less of B₂O₃, and 3% by mass or more and 5% by mass or less in total of Na₂O and K₂O.

The content of the inorganic filler (a2) in the resin molding material constituting the resin member is preferably 13.0% by mass or more and 37.0% by mass or less based on the total of the resin mixture (a1) and the inorganic filler (a2) as 100% by mass. The content of the inorganic filler (a2) that is less than 13.0% by mass is not preferred since the resin member may be inferior in internal strength and may have an increased molding shrinkage ratio of the resin in molding, which makes the bonding to the metal insufficient. The content of the inorganic filler (a2) that exceeds 37.0% by mass is not preferred since the dielectric constant of the resulting resin metal composite body may be increased. The content of the inorganic filler (a2) is preferably 15.0% by mass or more, and more preferably 18.0% by mass or more, and is preferably 35.0% by mass or less, and more preferably 33.0% by mass or less.

The resin member constituting the resin metal composite body of the present invention may be prepared in such a manner that the aforementioned essential components and the arbitrary components used depending on demand are mixed at the prescribed ratios and sufficiently kneaded with a Banbury mixer, a single screw extruder, a twin screw extruder, or the like, at an appropriate temperature, for example, a temperature in a range of 270 to 320° C. The resin member may be molded into a desired form, for example, a pellet form, by various molding methods.

As a result of the investigations on the mechanism of fracture of the resin metal composite body of the present invention on the assumption of the situation of the practical use thereof, focusing on the resin mixture (a1) assumed to exist in the vicinity of the interface between the resin member and the metal member, the resin metal composite body can have excellent bonding strength by imparting the particular strength to the resin mixture (a1).

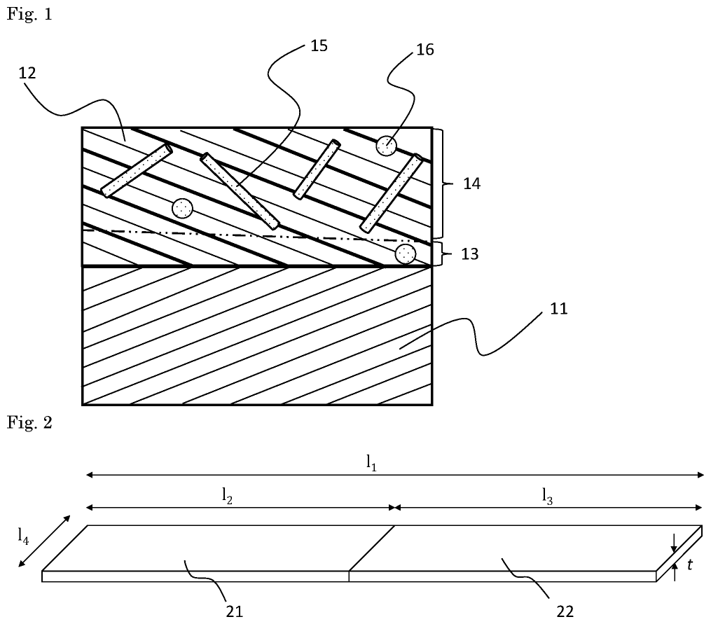

The mechanism will be described specifically with reference to FIG. 1. As shown in FIG. 1, it is considered that the resin member 12 bonded to the metal member 11 is formed of a skin layer 13 existing in the vicinity of the interface to the metal member and a core layer 14. The resin member contains the inorganic filler 15 and the rubber-like elastomer 16. In molding the resin member, it is considered that the inorganic filler (a2) 15 having a small specific gravity is contained in the core layer 14, and it is assumed that the skin layer referred in the present invention substantially does not contain the inorganic filler (a2). The expression “substantially does not contain” means that the amount of the inorganic filler (a2) in the skin layer is 0.3% by mass or less, more preferably 0.2% by mass or less, and substantially 0.0% by mass, based on the total amount of the resin molding material.

In the integral molding of the metal member and the resin member for providing the resin metal composite body described later, it is considered that the inorganic filler (a2) having a small specific gravity in the resin member migrates to the core layer, and therefore it is assumed that the skin layer in the vicinity of the interface in contact with the metal substantially does not contain the inorganic filler (a2).

In the situation of the practical use of the metal composite body as a chassis of an electronic or electric component, the fracture of the metal composite body occurs frequently in such a mechanism that a crack firstly occurs in the skin layer, and the crack propagates to the core layer to cause finally fracture of the composite body. Therefore, it is considered that the properties of the skin layer are important.

In the present invention, it has been found that focusing on the mechanical strength of the resin molded body formed of the resin mixture (a1) that substantially does not contain the inorganic filler (a2), the resin metal composite body having excellent bonding strength can be obtained as a result of imparting the particular properties are imparted thereto.

<Properties demanded for Molded Body formed of Resin Mixture (a1)>

### (I): Yield Point and Tensile Yield Stress

It is necessary that a molded body formed of the resin mixture (a1) has a stress-strain curve having a yield point obtained in a tensile test according to ISO 527-1,2:2012, and a tensile yield stress of 25 MPa or more. While the mechanism is unclear, the present inventors have found that in the case where the molded body formed of the resin mixture (a1) has a yield point, i.e., undergoes plastic deformation rather than elastic fracture, the excellent bonding strength, such as the exfoliation strength, can be obtained. Furthermore, the tensile yield stress that is less than 25 MPa is not preferred since the resin metal composite body finally obtained becomes inferior in strength. The tensile yield stress of the molded body formed of the resin mixture (a1) is preferably 28 MPa or more, more preferably 30 MPa or more, and further preferably 35 MPa or more.

### (II): Nominal Tensile Fracture Strain

As described above, the molded body formed of the resin mixture (a1) preferably exhibits a plastic deformation behavior, in which the starting point of the plastic deformation is the yield point, and the stress at the yield point is the tensile yield stress. As an index of the yield strength, the nominal tensile fracture strain can be referred in addition to the yield point and the tensile yield stress. It is preferred that the strength design is performed to achieve a nominal tensile fracture strain of 2.5% or more in a tensile test according to ISO 527-1,2:2012. The resin mixture (a1) that has a nominal tensile fracture strain of 2.5% or more may be excellent in viscoelasticity and can enhance the strength of the resin metal composite body finally obtained.

The nominal tensile fracture strain is more preferably 2.7% or more, more preferably 2.8% or more, and further preferably 3.0% or more.

(III): Loss Tangent (tan δ) of Solid Viscoelasticity The resin mixture (a1) preferably has a loss tangent (tan δ) of solid viscoelasticity of a test specimen thereof of 20 mm×5 mm×0.8 mm in thickness of 0.0200 or more, and more preferably 0.0220 or more, measured under condition of a frequency of 1 Hz and around room temperature according to ISO 6721-4:1994. With the loss tangent (tan δ) measured under the condition of 0.0200 or more, the excellent bonding strength can be retained against the cleavage and exfoliation occurring due to uneven application of a stress to one side or an edge of the bonding surface between the metal member and the resin member.

In general, a resin composition is a viscoelastic body having both viscosity and elasticity, and the loss tangent (tan δ) of solid viscoelasticity can be used as an index showing the viscoelasticity. In an ideal viscoelastic body, the stress and the strain are observed in the same phase. In an ideal liquid, the phase of the strain is delayed from the phase of stress by 90 degrees. A viscoelastic body exhibits a behavior intermediate therebetween, and the phase difference is a value between 0 degree and 90 degrees.

The loss tangent (tan δ) of solid viscoelasticity is a value obtained by dividing the contribution of viscosity to the mechanical properties of the material by the contribution of elasticity thereto as described in detail later, and with a value thereof closer to 0, the material is closer to an elastic body, whereas with a larger value thereof, the material is closer to a viscous body. A material having a large loss tangent has a viscous starch syrup-like nature and exhibits high viscosity in deformation.

The elastic modulus can be expressed as a complex elastic modulus G*, which is a ratio of the stress (σ*) and the strain (γ*), according to the following expression (F1).

G*=σ*/γ*=(σ0/γ0)eⁱδ=(σ0/γ0)(cos δ+i sin δ) (F1)

Assuming that the complex elastic modulus G* is separated into the real part and the imaginary part according to the following expression (F2), the real part G′ shows the elastic part of the viscoelasticity, and the imaginary part G″ in a phase delayed therefrom by 90 degree shows the viscous part thereof. G′ and G″ are referred to as the storage elastic modulus and the loss elastic modulus respectively, and the loss tangent (tan δ) is shown by tan δ=G″/G′.

G*=G′+iG″ (F2)

By applying an oscillatory deformation to a measurement specimen, and measuring the amplitude of the strain, the amplitude of the stress detected with a stress meter, and the phase difference therebetween, the contribution of elasticity and the contribution of viscosity of the viscoelastic body can be evaluated.

The present inventors have found that in the case where the measurement of the loss tangent (tan δ) of solid viscoelasticity of a molded body of the resin mixture (a1) reveals 0.0200 or more, the composite body including the resin member formed of the resin molding material and the metal member bonded to each other has increased bonding strength and is further hard to undergo exfoliation.

The resin member constituting the resin metal composite body of the present invention further has a low dielectric constant. Specifically, a test specimen of 1.5 mm×1.5 mm×80 mm in thickness of the resin molding material preferably has a relative dielectric constant (εᵣ) of 3.50 or less, and more preferably 3.10 or less, measured at a frequency of 10 GHz according to ASTM D2520.

In addition, the resin molding material constituting the resin metal composite body of the present invention may also have a low dissipation factor as one of the characteristic features. Specifically, the test specimen of 1.5 mm×1.5 mm×80 mm of the resin molding material preferably has a dissipation factor of 0.0100 or less, and more preferably 0.0050 or less, measured at a frequency of 10 GHz according to ASTM D2520. The relative dielectric constant (εᵣ) and the dissipation factor that are in the ranges can provide an advantage that the transmission rate of signals in a high frequency band is not delayed, and the intensity of the signals is not lowered.

### 2. Metal Member

The metal member constituting the resin metal composite body of the present invention is preferably at least one kind selected from the group consisting of aluminum, stainless steel, copper, titanium, and alloys thereof. These metals may be selected depending on the target application and properties, and aluminum and an aluminum alloy are more preferably used. Examples of the aluminum and the aluminum alloy containing aluminum include A1050, A1100, and A1200 as an industrial pure aluminum series, A2017 and A2024 as an Al—Cu series, A3003 and A3004 as an Al—Mn series, A4032 as an Al—Si series, A5005, A5052, and A5083 as an Al—Mg series, A6061 and A6063 as an Al—Mg—Si series, and A7075 as an Al—Zn series. In the case where the resin metal composite body is used as a chassis of an information and communications instrument, such as a mobile phone, aluminum and stainless steel are preferred from the standpoint of working.

The shape of the metal member is not particularly limited, as far as the shape enables bonding to the resin member, and examples thereof include a flat plate shape, a curved plate shape, a bar shape, a cylindrical shape, and a bulk shape. A structure including a combination of these shapes may also be used. The form of the surface of the bonding portion, through which the resin member is bonded, is not particularly limited, and examples thereof include a flat surface and a curved surface. A form that can suppress the stress concentration is more preferred for retaining the bonding strength.

The metal member may be provided through die-cast molding, extrusion molding, or the like of a metal material. It is preferred that the metal material obtained through the molding and the like is worked into a prescribed shape by subjecting to plastic working by cutting, pressing, or the like, punching work, and cutout work, such as cutting, grinding, electrospark machining, and the like, and then subjected to a surface treatment described later.

The metal member may be subjected to a surface treatment, such as physical, chemical, or electric surface roughening, and is preferably subjected to at least one selected from a physical treatment and a chemical treatment. In the case where at least a part of, preferably the whole of, the surface of the metal member that is in contact with the resin member is subjected to the surface treatment, the resin metal composite body having particularly excellent bonding capability between the metal member and the resin member can be obtained.

The physical treatment and the chemical treatment are not particularly limited, and the known physical treatments and chemical treatments may be used. The physical treatment roughens the surface of the metal member, and the resin mixture constituting the resin member enters the pores formed in the roughened area to generate the anchoring effect, which facilitates the enhancement of the adhesiveness at the interface between the metal member and the resin member. The chemical treatment imparts a chemical adhesion effect, such as covalent bond, hydrogen bond, and intermolecular force, to between the metal member and the resin member integrally molded therewith, which thus facilitates the enhancement of the adhesiveness at the interface between the metal member and the resin member. The chemical treatment may also perform roughening of the surface of the metal member, and in this case, the anchoring effect is generated as similar to the physical treatment, which further facilitates the enhancement of the adhesiveness at the interface between the metal member and the resin member.

Various methods may be used as the method of the surface treatment. Examples of the physical treatment include a laser treatment and sand blasting (see JP 2001-225346 A). Plural physical treatments may be used in combination. Examples of the chemical treatment include a dry treatment, such as corona discharge, a triazine treatment (see JP 2000-218935 A), chemical etching (see JP 2001-225352 A), an anodization treatment (see JP 2010-64496 A), and a hydrazine treatment. In the case where the metal material constituting the insert metal member is aluminum, examples of the treatment also include a hot water treatment (see JP H08-142110 A). Examples of the hot water treatment include immersion in water at 100° C. for 3 to 5 minutes. Plural chemical treatments may be used in combination. The methods of the surface treatment may be used alone or as a combination of two or more kinds thereof.

For enhancing the anchoring effect of the metal member, it is preferred that pores are formed on at least a part of the surface of the metal member that is in contact with the resin member. Specifically, it is preferred that large pores are formed on the surface of the metal member, and fine pores are further formed in the pores.

The case where the metal member is aluminum or an aluminum alloy (which may be hereinafter referred to as an aluminum (alloy)) will be specifically described below.

In bonding a metal and a resin through injection molding or the like, an aluminum (alloy) can be worked from a metal material to a desired shape through machining, such as sawing, milling, discharging, drilling, forging, pressing, cutting, and grinding, and thus can be finished to a shape that is required for an insert member to an injection molding die. The metal member having been finished to the necessary shape generally has attached thereto an oil material used in working in many cases. Therefore, a degreasing treatment is preferably performed before the formation of fine pores on the surface thereof. The degreasing treatment is preferably a process of removing the working fluid by using a solvent degreasing equipment with a solvent, such as trichlene, methylene chloride, kerosene, and a paraffin-based oil agent.

Subsequently, a degreasing and cleaning treatment in a liquid is preferably performed. This is performed for removing the working fluid for the machining, such as cutting and grinding, dirt, such as sebum of fingers, and the like attached to the surface of the aluminum (alloy). In the case where a large amount of the working fluid is attached, it is preferred that the aluminum (alloy) is firstly subjected to the aforementioned solvent degreasing equipment, and then subjected to this treatment. The degreasing agent used herein may be a commercially available degreasing agent for an aluminum alloy. In the use of a commercially available degreasing agent for an aluminum alloy, it is preferred that the degreasing agent is dissolved in water to prepare a degreasing agent aqueous solution, in which the aluminum (alloy) member is immersed at the specified temperature for the specified time, for example, at 50 to 80° C. for approximately 5 minutes. After immersing, the aluminum (alloy) member is cleaned with water.

A pretreatment process is preferably performed in such a manner that the aluminum (alloy) member is roughly etched by immersing in an acidic or basic solution for several minutes for chemically removing the surface film, and then an anodization treatment or the like is performed for forming fine pores. In the pretreatment process, an acidic aqueous solution is preferably used, and an aqueous solution containing hydrofluoric acid or a derivative of hydrofluoric acid may be used as the acidic liquid. It is preferred that the aluminum (alloy) member is roughly etched by immersing in an acidic or basic solution for several minutes for chemically removing the surface film, so as to make suitable for the subsequent process. After cleaning with water, the aluminum (alloy) member is subjected to a treatment for forming fine pores.

Examples of the method of forming fine pores on the metal surface include a method using laser, as described in Japanese Patent No. 4,020,957; a method of treating the metal member by an anodization method, as described in Japanese Patent No. 4,541,153; a substitution crystallization method of etching with an aqueous solution containing an inorganic acid, ferric ion, cupric ion, and manganese ion, as described in JP 2001-348684 A; and a method of immersing the metal member in an aqueous solution of one or more selected from hydrated hydrazine, ammonia, and a water soluble amine compound (which may be hereinafter referred to as an NMT method), as described in WO 2009/31632. Among these, a method of treating the metal member by an anodization method, as described in Japanese Patent No. 4,541,153, is preferred.

The metal member preferably has plural pores having a diameter of 0.01 μm or more and 1,000 μm or less formed on the surface that is in contact with the resin member. With plural pores having a diameter of 0.01 μm or more and 1,000 μm or less formed thereon, the resin metal composite body that is further excellent in bonding capability between the metal member and the resin member can be obtained. The pores are more preferably 0.01 μm or more and 100 μm or less.

3. Method for producing Resin Metal Composite Body

The resin metal composite body can be obtained by integrally molding the metal member and the resin member. Examples of the integral molding method include insert molding, fusion method, outsert molding, and overlay molding.

The “insert molding” is a method for providing a molded body having the metal member and the resin member integrated with each other by inserting the metal member into a mold having a prescribed shape, and then filling the mold with the resin member, and a known method may be employed therefor. The method is not particularly limited, as far as the method can provide the resin metal composite body by charging the resin into the pores formed on the metal member, for example, by applying pressure to the molten resin, followed by cooling and solidifying the resin. Examples of the filling method of the resin include injection molding and compression molding, and also include injection compression molding, and an injection molding method is more preferred.

The method for retaining the metal member in the mold is not particularly limited, and a known method may be used, examples of which include a method of fixing with a pin or the like, and a method of fixing with a vacuum line. The insert molded body obtained through insert molding has the bonding portion between the resin member and the metal member, and the shape thereof is not limited. Examples thereof include a shape having the resin member and the metal member overlaid each other, and a shape having the metal member enclosed with the resin member.

The temperature of the metal member in the insert molding is preferably such a temperature that is higher by 50° C. to 80° C. than the glass transition temperature of the resins (1) to (5) as the major component of the resin mixture (a1). For example, in the case where the resin (1), a syndiotactic polystyrene, is used, the temperature is preferably 150° C. or more and 180° C. or less, and in the case where a polybutylene terephthalate, which is one of the resin (2), a polyester, is used, the temperature is preferably 110° C. or more and 140° C. or less. In the case where the temperature of the metal member is higher by 50° C. or more than the glass transition temperature of the resin as the major component of the resin mixture (a1), the pores formed on the metal member can be sufficiently filled with the resin member, and an excellent bonding strength can be obtained. In the case where the temperature of the metal member exceeds a temperature that is higher by 80° C. or more than the glass transition temperature of the resin as the major component of the resin mixture (a1), the shrinkage and deformation of the resin member in the cooling process may be increased to prevent the target shape from being obtained, and simultaneously, the energy necessary for heating and cooling may be increased, and the molding cycle time may be increased.

The method for making the temperature of the metal member within the aforementioned range is not particularly limited, and examples thereof include a controlling method through a temperature controlling mechanism of the mold.

In the method of performing integral molding by the fusion method, the resin member is fused on the metal member through vibration fusion, ultrasonic fusion, hot plate fusion, or spin fusion. The fusion condition for performing the fusion is not particularly limited, and may be appropriately set depending on the shape of the molded body and the like.

The fusion method is preferably a method which includes bringing the metal member and the resin member into contact with each other, and generating frictional heat at the contact surface thereof to perform the fusion. Examples of the fusion method which includes generating frictional heat at the contact surface include a vibration fusion method, an ultrasonic fusion method, and a spin fusion method.

The size, the shape, the thickness, and the like of the resulting resin metal composite body are not particularly limited, and may be any of a plate shape (such as a circular shape and a polygonal shape), a column shape, a box shape, a bowl shape, a tray shape, and the like. In the large-size composite body and the composite body having a complicated shape, the thickness of the composite body may not be necessarily uniform over the entire portion of the composite body, and a reinforcing rib may be provided in the composite body.

The resulting resin metal composite body may be further worked by cutting work, grinding work, and the like. Examples of the cutting work include turning, milling, boring, drilling (such as perforating, tapping, and reaming), gear cutting, plaining, shaping, slotting, broaching, and gear shaping. A known working fluid is preferably used in the cutting work.

The working fluid may also be preferably used in both wet working and near dry working. The method of feeding the working fluid may be circulation feeding of feeding a large amount of the working fluid to the working point, or may be a so-called MQL (minimum quantity lubrication) of feeding a carrier gas and a metal working fluid composition in the form of mist to the working point.

The surface of the resin metal composite body before working and the resin metal composite body after the aforementioned working is preferably subjected to a physical treatment and/or a chemical treatment. These treatments performed can impart design, such as coloration, to the resin metal composite body and can protect and strengthen the surface of the resin metal composite body.

The treatment of the surface of the resin metal composite body may be the same method as described above. For example, in the case where a chemical treatment is performed, as described above, such a method may be used that the working fluid used for working the resin metal composite body is removed by degreasing, the surface is roughly etched with an acidic or basic solution, and then fine pores are formed on the surface. The method of forming fine pores on the surface herein is also preferably an anodization treatment. The condition therefor may be as described above.

The resin metal composite body after the anodization treatment may be applied to various purposes without any further treatment, but the anodized film formed after the anodization treatment is relatively inferior in electric insulation property and corrosion resistance. Therefore, the portion of the resin metal composite body that is exposed to outside air is preferably subjected to a pore sealing treatment. Examples of the pore sealing treatment include a pore sealing treatment with a hydrate. More specifically, examples thereof include a steam treatment and a hot water treatment applied to an anodized film having fine pores formed by an anodization treatment. In the case where the resin metal composite body is colored, the pore sealing treatment may be performed while coloring to a desired color through a known desired coloration measure, such as various dyes, e.g., the use of an acidic dye, a mordant dye, and a basic dye, for example, by using a dye bath at a bath temperature of 50 to 70° C. The resin used in the resin member of the resin metal composite body of the present invention is preferred from the standpoint of the treatment of this type, since it is excellent in chemical resistance and hot water resistance, and thus can withstand the treatment.

As the surface layer of the resin metal composite body of the present invention, a hardcoat layer may be provided for the purpose of scratch prevention, fingerprint prevention, static charge prevention, and the like. The hardcoat layer used may be an arbitrary one, and for example, a film formed of a photocurable composition containing a photocurable polyfunctional compound and a urethane (meth)acrylate may be formed on the metal resin composite body.

### EXAMPLES

The present invention will be described more specifically with reference to examples, but the present invention is not limited thereto.

The materials used in Examples and Comparative Examples are shown below.

<Resin Mixture (a1)>

Resin (1): Polystyrene polymer having syndiotactic structure (SPS)

(1-1): Syndiotactic polystyrene homopolymer, produced by Idemitsu Kosan Co., Ltd., trade name: 90ZC, melting point: 270° C., racemic pentad tacticity: 98%, MFR: 9.0 g/10 min (temperature: 300° C., load: 1.2 kgf)

(1-2): Syndiotactic polystyrene homopolymer, produced by Idemitsu Kosan Co., Ltd., trade name: 60ZC, melting point: 270° C., racemic pentad tacticity: 98%, MFR: 6.0 g/10 min (temperature: 300° C., load: 1.2 kgf)

(1-3): Syndiotactic polystyrene homopolymer, produced by Idemitsu Kosan Co., Ltd., trade name: 30ZC, melting point: 270° C., racemic pentad tacticity: 98%, MFR: 3.0 g/10 min (temperature: 300° C., load: 1.2 kgf)

Resin (2): Polyester, produced by Toray Industries, Inc., polybutylene terephthalate (PBT), trade name: Toraycon 1401 X06, MFR: 11.6 g/10 min (temperature: 250° C., load: 2.16 kgf)

Rubber-like elastomer (1): Styrene-ethylene-butylene-styrene block copolymer, styrene content: 33% by mass, produced by Kuraray Co., Ltd., trade name: Septon 8006, MFR: 0.0 g/10 min (no flow) (temperature: 230° C., load: 2.16 kgf)

Rubber-like elastomer (2): Styrene-ethylene-butylene-styrene block copolymer, styrene content: 30% by mass, produced by Asahi Kasei Corporation, trade name: Tuftec H1041, MFR: 5.0 g/10 min (temperature: 230° C., load: 2.16 kgf)

Rubber-like elastomer (3): Ethylene-glycidyl methacrylate copolymer, produced by Sumitomo Chemical Co., Ltd., trade name: Bondfast E

### Acid-Modified Polyphenylene Ether (C)

1 kg of a polyphenylene ether (intrinsic viscosity: 0.45 dL/g, in chloroform at 25° C.), 40 g of fumaric acid, and 20 g of 2,3-dimethyl-2,3-diphenylbutane (produced by NOF Corporation, trade name: Nofmer BC) as a radical generator were dry-blended and melt-kneaded with a twin screw extruder, TEX44αII (produced by The Japan Steel Works, Ltd.) at a barrel temperature of 300 to 330° C., a screw rotation number: 360 rpm, and a discharge rate of 110 kg/hr, so as to provide pellets of a fumaric acid-modified polyphenylene ether. For measuring the modification rate, 1 g of the fumaric acid-modified polyphenylene ether pellets were dissolved in ethylbenzene and the reprecipitated from methanol, and the recovered polymer was subjected to Soxhlet extraction with methanol, and after drying, measured for the modification rate by the carbonyl absorption intensity in the IR spectrum and the titration. The modification rate at this time was 1.25% by mass.

The fumaric acid-modified polyphenylene ether obtained above was used.

Nucleating agent: sodium 2,2′-methylenebis(4,6-di-tert-butylphenyl)phosphate, produced by ADEKA Corporation, trade name: Adeka Stab NA-11

Phenol-based antioxidant: trade name: Irganox 1010, produced by BASF Japan Ltd.

Inorganic Filler (a2)

Glass filler (1): ECS03T-249H (produced by Nippon Electric Glass Co., Ltd., E glass, fibrous (chopped strand length: 3 mm), fiber cross section: approximate true circler shape (diameter: 10.5 μm))

Glass filler (2): CSG3PA-820 (produced by Nitto Boseki Co., Ltd., E glass, fibrous (chopped strand length: 3 mm), fiber cross section: ellipsoidal shape (short diameter: 7 μm, long diameter: 28 μm))

Glass filler (3): ECS03T-187H (produced by Nippon Electric Glass Co., Ltd., E glass, fibrous (chopped strand length: 3 mm), fiber cross section: approximate true circler shape (diameter: 10.5 μm))

Glass filler (4): CSG3PA-830 (produced by Nitto Boseki Co., Ltd., E glass, fibrous (chopped strand length: 3 mm), fiber cross section: ellipsoidal shape (short diameter: 7 μm, long diameter: 28 μm))

Glass filler (5): CS(HL)303N-3 (produced by CPIC, D glass, fibrous (chopped strand length: 3 mm), fiber cross section: approximate true circler shape (diameter: 13 μm))

### [Evaluation Methods]

### I. Production of Pellets of Resin Mixture (a1)

The resin mixtures (a1) (i.e., the components constituting the resin member except for the inorganic filler) shown in Tables 1 to 5 each were mixed and dry-blended with a Henschel mixer. Subsequently, the dry-blended resin mixture (a1) was melt-kneaded with a twin screw kneader-extruder, TEM-35B (produced by Toshiba Machine Co., Ltd.), under condition of a barrel temperature of 270 to 290° C. for the SPS resin or a barrel temperature of 240 to 260° C. for the PBT resin, at a screw rotation number of 220 rpm, and a discharge rate of 25 kg/hr, so as to provide pellets. The pellets obtained through the melt kneading were dried at 120° C. for 5 hours with a hot air dryer, and evaluated. The evaluation methods for the resulting pellets were as follows.

### II. Production of Pellets of Resin Molding Material Containing Resin Mixture (a1) and Inorganic Filler (a2)

For the resin molding material containing the inorganic filler (a2), after dry-blending the resin mixture (a1) as described in the item I above, the inorganic filler was melt-kneaded therewith by feeding the inorganic filler in the amount shown in the table with a twin screw kneader-extruder, TEM-35B (produced by Toshiba Machine Co., Ltd.), under condition of a barrel temperature of 270 to 290° C. for the SPS resin or a barrel temperature of 240 to 260° C. for the PBT resin, at a screw rotation number of 220 rpm, and a discharge rate of 25 kg/hr, so as to provide pellets of the resin molding material. The resulting pellets were dried at 120° C. for 5 hours with a hot air dryer. The resulting pellets were subjected to the evaluation below.

### 1. Tensile Test

A dumbbell test specimen having a thickness of 4 mm was molded from each of the pellets obtained in the items I and II above with an injection molding machine, SE100EV (produced by Sumitomo Heavy Industries, Ltd.), under condition of a resin temperature of 290° C. and a mold surface temperature of 160° C. for the SPS resin or a resin temperature of 260° C. and a mold surface temperature of 120° C. for the PBT resin, and subjected to a tensile test at a test speed of 50 mm/min according to ISO 527-1,2:2012 to provide a stress-strain curve, from which the presence of a yield point, the tensile yield stress, and the nominal tensile fracture strain were measured. The results are shown in Tables 1 to 5.

### 2. Izod Impact Strength

A specimen of 100 mm×10 mm×4 mm in thickness formed of each of the pellets obtained in the items I and II above was molded with an injection molding machine, SE100EV (produced by Sumitomo Heavy Industries, Ltd.), under condition of a resin temperature of 290° C. and a mold surface temperature of 160° C. for the SPS resin or a resin temperature of 260° C. and a mold surface temperature of 120° C. for the PBT resin, and after forming a notch with a notching machine, measured for the Izod impact strength (with notch) according to ISO 180:2000. The results are shown in Tables 1 to 5.

### 3. Evaluation of Loss Tangent (tan δ) of Solid Viscoelasticity

A specimen for evaluation of 20 mm×5 mm×0.8 mm in thickness formed of each of the pellets obtained in the item I above was molded with an injection molding machine, SE100EV (produced by Sumitomo Heavy Industries, Ltd.), under condition of a resin temperature of 290° C. and a mold surface temperature of 160° C. for the SPS resin or a resin temperature of 260° C. and a mold surface temperature of 120° C. for the PBT resin. The specimen was measured for the loss tangent (tan δ) of solid viscoelasticity with DMS 6100, produced by Seiko Instruments Inc., according to ISO 6721-4:1994. The measurement was performed under condition of a temperature increasing rate of 2° C./min, a temperature range of −40 to 200° C., and a frequency of 1 Hz. An average value of the data of 25 to 35° C. was calculated. The results are shown in Tables 1 to 5.

### 4. TD Bending Test

A specimen of 80 mm×80 mm×3 mm in thickness formed of each of the pellets obtained in the item II above was molded with an injection molding machine, SE100EV (produced by Sumitomo Heavy Industries, Ltd.), under condition of a resin temperature of 290° C. and a mold surface temperature of 160° C. for the SPS resin or a resin temperature of 260° C. and a mold surface temperature of 120° C. for the PBT resin, from which a test specimen of 80 mm×10 mm×3 mm in thickness was then cut out in the direction (TD) perpendicular to the flowing direction of the resin, and measured for the TD bending elastic modulus according to ISO 178:2010. The results are shown in Tables 1 to 5.

### 5. Evaluation of Dielectric Characteristics (Relative Dielectric Constant and Dissipation Factor)

A test specimen of 1.5 mm×1.5 mm×80 mm formed of each of the pellets obtained in the item II above was molded with an injection molding machine, SE100EV (produced by Sumitomo Heavy Industries, Ltd.), under condition of a resin temperature of 290° C. and a mold surface temperature of 160° C. for the SPS resin or a resin temperature of 260° C. and a mold surface temperature of 120° C. for the PBT resin, and measured for the relative dielectric constant (εᵣ) and the dissipation factor at 10 GHz by the cavity resonance perturbation method according to ASTM D2520 with a network analyzer, 8757D, produced by Agilent Technologies, Inc., and a cavity resonator for 10 GHz, produced by Kanto Electronic Application and Development Inc. The results are shown in Tables 1 to 5.

### Examples 1 to 26 and Comparative Examples 1 to 3

The surface of an aluminum alloy A6063 (dimension: 50 mm in length×10 mm in width×2 mm in thickness) was subjected to a degreasing treatment by immersing in an alkali degreasing solution (aqueous solution: AS-165F (produced by JCU Corporation), 50 mL/L) for 5 minutes. Subsequently, a pretreatment was performed by acid etching. Thereafter, an anodization treatment was performed to produce a metal member having plural pores. The resulting aluminum member was placed in a mold, and each of the resin molding materials (pellets) shown in Tables 1 to 5 was injection-molded to perform an integration process with the resin member with an injection molding machine, SE100EV (produced by Sumitomo Heavy Industries, Ltd.), under condition of a resin temperature of 290° C. and a mold surface temperature of 160° C. for the SPS resin or a resin temperature of 260° C. and a mold surface temperature of 120° C. for the PBT resin, an injection speed of 100 mm/s, a holding pressure of 80 MPa, and a holding pressure time of 5 seconds, so as to provide a test specimen of the resin metal molded body. The test specimen was produced according to ISO 19095:2015 (see FIG. 2). In FIG. 2, I₁ denotes the length of the test specimen, I₂ denotes the length of the metal member 21, I₃ denotes the length of the resin member 22, I₄ denotes the width of the test specimen, and t denotes the thickness of the test specimen. I₁ was 100 mm, I₂ and I₃ each were 50 mm, I₄ was 10 mm, and t was 2 mm. The resulting test specimen was annealed at 160° C. for 1 hour, and then the test specimen was subjected to the pretreatment, the anodization treatment, and the pore sealing treatment shown below. As the pretreatment, alkali degreasing was performed by immersing in a 2.0% by mass sodium hydroxide aqueous solution at 50° C. for 1 minute, and then neutralized with 6.0% by mass diluted nitric acid (at ordinary temperature for 30 seconds). Subsequently, the specimen was chemically ground with a 90% by mass phosphoric acid-10% by mass sulfuric acid system at 86° C. for 2 minutes, and then desmutted with 6.0% by mass diluted nitric acid. The test specimen having been subjected to the pretreatment was subjected to the anodization treatment (18% by mass sulfuric acid, 18° C., 39 minutes, 1 A/dm²), and then subjected to a hot water treatment (pore sealing treatment), followed by air-blowing.

### <Evaluation Method of Resin Metal Composite Body>

### 6. Tensile Bonding Strength

Specimens of the metal resin composite bodies obtained in Examples and Comparative Examples each were measured for the tensile bonding strength according to ISO 19095:2015. The results are shown in Tables 1 to 5.

### 7. Drop Impact (Six-Side Impact)

On the assumption of the use of the resin metal composite body of the present invention as a smartphone chassis, the bonding strength was evaluated under condition close to the actual equipment.

A test specimen for the drop impact test was produced in the following manner by changing the dimension of the metal member and a part of the molding condition of the metal resin composite body in the production method of the test specimen used for the measurement of the tensile bonding strength.

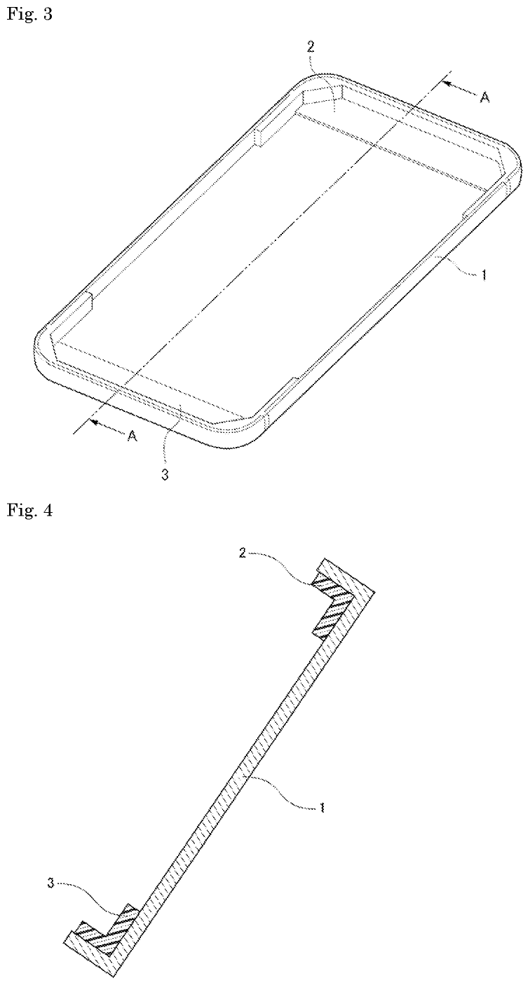

An aluminum alloy A6063 body (dimension: 160×100×10 mm in thickness) was cut for removing a portion to be filled with the resin member using a working fluid (Alphacool WA-K, produced by Idemitsu Kosan Co., Ltd.), and the surface thereof was subjected to a degreasing treatment by immersing in an alkali degreasing solution (aqueous solution: AS-165F (produced by JCU Corporation), 50 mL/L) for 5 minutes. Subsequently, a pretreatment was performed by acid etching. Thereafter, an insert metal member having plural pores on the surface thereof was produced by the anodization method. The resulting insert metal member was placed in a mold, and each of the resin molding materials (pellets) shown in Tables 1 to 5 was injection-molded to perform an integration process with the metal member with an injection molding machine, SE100EV (produced by Sumitomo Heavy Industries, Ltd.), under condition of a resin temperature of 290° C. and a mold surface temperature of 160° C. for the SPS resin or a resin temperature of 260° C. and a mold surface temperature of 120° C. for the PBT resin, an injection speed of 100 mm/s, a holding pressure of 80 MPa, and a holding pressure time of 5 seconds, so as to provide a resin metal molded body. The resulting resin metal molded body was cut for removing the unnecessary parts of resin and metal using a working fluid (Alphacool WA-K, produced by Idemitsu Kosan Co., Ltd.), so as to provide a molded body simulating a smartphone chassis (see FIGS. 3 and 4).

The resulting molded body simulating a smartphone chassis was further subjected to a surface treatment. As the pretreatment, alkali degreasing was performed by immersing in a 2.0% by mass sodium hydroxide aqueous solution at 50° C. for 1 minute, and then neutralized with 6.0% by mass diluted nitric acid (at ordinary temperature for 30 seconds). Subsequently, the molded body was chemically ground with a 90% by mass phosphoric acid-10% by mass sulfuric acid system at 86° C. for 2 minutes, and then desmutted with 6.0% by mass diluted nitric acid. The molded body having been subjected to the pretreatment was subjected to the anodization treatment (18% by mass sulfuric acid, 18° C., 39 minutes, 1 A/dm²), and then subjected to a hot water treatment (pore sealing treatment), followed by air-blowing.

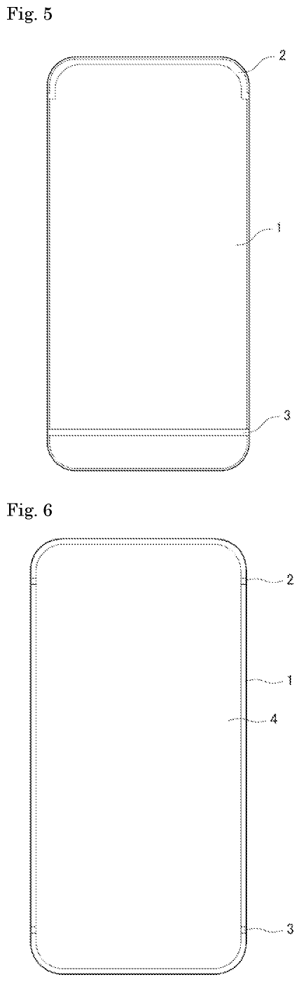

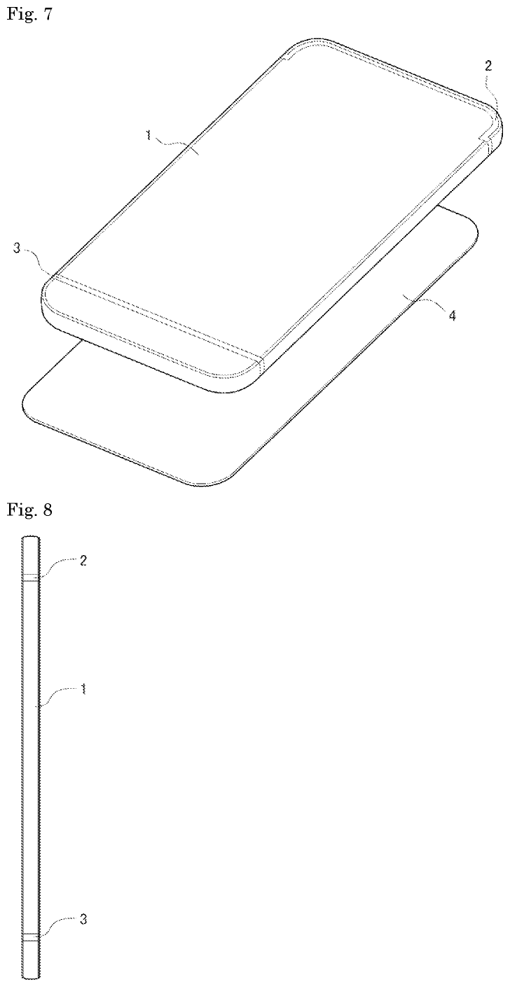

A specimen for a drop impact test was produced by combining a component for mass adjustment (which was glass in Examples and Comparative Examples) with the resin metal composite body simulating a smartphone chassis obtained making a total mass of 150 g (see FIGS. 5 to 8) uniformly. Specifically, as shown in FIG. 7, a glass plate 4 as a component for mass adjustment was inserted in the metal resin composite body simulating a smartphone chassis, so as to provide a specimen for a drop impact test having the rear view shown in FIG. 5 and the front view shown in FIG. 6. FIG. 8 is a side view of the specimen, and as shown in the figures, the portions denoted by the symbols 2 and 3 were the resin member portions bonded to the metal member 1.

The resulting specimen for a drop impact test was dropped from each of the six sides thereof from a height of 1 m to a concrete plate with a drop tester for light weight products, DT-205H (produced by Shinyei Technology Co., Ltd.), and the occurrence of problems, such as exfoliation of the resin-metal bonding surface and fracture of the resin member, was visually confirmed.

A: No fracture was visually confirmed in the drop impact test.

B: Fracture was visually confirmed in the drop impact test.

In the tables, the contents (% by mass) of the resin (1), the resin (2), the rubber-like elastomer (B), and the acid-modified polyphenylene ether (C) are shown in terms of proportion in the resin component in the resin mixture (a1) as 100% by mass. The contents (part by mass) of the nucleating agent and the antioxidant are shown in terms of content per 100 parts by mass of the resin component in the resin mixture (a1). The content (% by mass) of the inorganic filler (a2) is shown in terms of proportion in the total of the resin mixture (a1) and the inorganic filler (a2) as 100% by mass.

TABLE 1

| | | | | | Example | | | | | |
|---|---|---|---|---|---|---|---|---|---|---|
| | | | | | 1 | 2 | 3 | 4 | 5 | 6 |
| Resin | Resin | Resin (1): | 90ZC | % by | 78.0 | 78.0 | 78.0 | 78.0 | 68.0 | 78.0 |
| molding | mixture | SPS | | mass | | | | | | |
| material | (a1) | Resin (2): | 1401 X06 | % by | | | | | | |
| | | Polyester | | mass | | | | | | |
| | | Rubber- | (1) Septon | % by | 20.0 | 20.0 | 20.0 | 20.0 | 30.0 | 15.0 |
| | | like | 8006 | mass | | | | | | |
| | | elastomer | (2) H1041 | % by | | | | | | 5.0 |
| | | (B) | | mass | | | | | | |
| | | | (3) Bondfast | % by | | | | | | |
| | | | E | mass | | | | | | |
| | | Acid-modified polyphenylene ether (C) | | % by | 2.0 | 2.0 | 2.0 | 2.0 | 2.0 | 2.0 |
| | | | | mass | | | | | | |
| | | Nucleating | NA-11 | part by | 0.5 | 0.5 | 0.5 | 0.5 | 0.5 | 0.5 |
| | | agent | | mass | | | | | | |
| | | Antioxidant | Irganox 1010 | part by | 0.3 | 0.3 | 0.3 | 0.3 | 0.3 | 0.3 |
| | | | | mass | | | | | | |
| | Resin mixture (a1)/inorganic filler (a2) (ratio in % by mass) | | | — | 80/20 | 75/25 | 70/30 | 60/40 | 70/30 | 70/30 |
| | Inorganic | Glass | (1) ECS03T- | % by | 20.0 | 25.0 | 30.0 | 40.0 | 30.0 | 30.0 |
| | filler | filler | 249H | mass | | | | | | |
| | (a2) | | (2) CSG3PA- | % by | | | | | | |
| | | | 820 | mass | | | | | | |
| | | | (3) ECS03T- | % by | | | | | | |
| | | | 187H | mass | | | | | | |

| | | | | | | | | | |
|---|---|---|---|---|---|---|---|---|---|
| Evaluation | Resin | Presence of yield point | - | yes | yes | yes | yes | yes | yes |
| result | mixture | Tensile yield stress | MPa | 38 | 38 | 38 | 38 | 31 | 39 |
| | (a1) | Nominal tensile | % | 6.9 | 6.9 | 6.9 | 6.9 | 19.7 | 14.0 |
| | | fracture strain | | | | | | | |
| | | Izod impact strength | KJ/m² | 5.9 | 5.9 | 5.9 | 5.9 | 7.8 | 8.4 |
| | | (with notch) | | | | | | | |
| | | Solid viscoelasticity | — | 0.0206 | 0.0206 | 0.0206 | 0.0206 | 0.0225 | 0.0229 |
| | | tanδ (average 25-35° C.) | | | | | | | |
| | Resin | Nominal tensile | % | 3.0 | 3.0 | 3.0 | 2.9 | 3.3 | 3.2 |
| | molding | fracture strain | | | | | | | |
| | material | Izod impact strength | KJ/m² | 11.6 | 12.2 | 12.8 | 14.9 | 16.4 | 14.8 |
| | | (with notch) | | | | | | | |
| | | Bending elastic | GPa | 3.1 | 3.7 | 4.3 | 5.3 | 3.9 | 4.3 |
| | | modulus (TD) | | | | | | | |
| | | Relative dielectric | — | 2.75 | 2.82 | 2.89 | 3.04 | 2.87 | 2.91 |
| | | constant (10 GHz) | | | | | | | |
| | | Dissipation factor | — | 0.0027 | 0.0031 | 0.0036 | 0.0044 | 0.0034 | 0.0034 |
| | | (10 GHz) | | | | | | | |
| | Resin | Tensile bonding | MPa | 25 | 27 | 28 | 30 | 23 | 26 |
| | metal | strength | | | | | | | |
| | composite | Drop impact | — | A | A | A | A | A | A |
| | body | (six-side impact) | | | | | | | |

TABLE 2

| | | | | | Example | | | | | | |
|---|---|---|---|---|---|---|---|---|---|---|---|
| | | | | | 7 | 8 | 9 | 10 | 11 | 12 | 13 |
| Resin | Resin | Resin (1): | 90ZC | % by | 68.0 | 78.0 | 78.0 | 68.0 | | | |
| molding | mixture | SPS | | mass | | | | | | | |
| material | (a1) | Resin (2): | 1401 X06 | % by | | | | | 95.0 | 90.0 | 80.0 |
| | | Polyester | | mass | | | | | | | |
| | | Rubber- | (1) Septon | % by | 25.0 | 20.0 | 15.0 | 25.0 | | | |
| | | like | 8006 | mass | | | | | | | |
| | | elastomer | (2) H1041 | % by | 5.0 | | 5.0 | 5.0 | | | |
| | | (B) | | mass | | | | | | | |
| | | | (3) Bondfast | % by | | | | | 5.0 | 10.0 | 20.0 |
| | | | E | mass | | | | | | | |
| | | Acid-modified polyphenylene ether (C) | | % by | 2.0 | 2.0 | 2.0 | 2.0 | | | |
| | | | | mass | | | | | | | |
| | | Nucleating | NA-11 | part by | 0.5 | 0.5 | 0.5 | 0.5 | | | |
| | | agent | | mass | | | | | | | |
| | | Antioxidant | Irganox 1010 | part by | 0.3 | 0.3 | 0.3 | 0.3 | | | |
| | | | | mass | | | | | | | |
| | Resin mixture (a1)/inorganic filler (a2) (ratio in % by mass) | | | — | 70/30 | 70/30 | 70/30 | 70/30 | 70/30 | 70/30 | 70/30 |
| | Inorganic | Glass | (1) ECS03T- | % by | 30 | | | | | | |
| | filler | filler | 249H | mass | | | | | | | |
| | (a2) | | (2) CSG3PA- | % by | | 30 | 30 | 30 | | | |
| | | | 820 | mass | | | | | | | |
| | | | (3) ECS03T- | % by | | | | | 30 | 30 | 30 |
| | | | 187H | mass | | | | | | | |

| | | | | | | | | | | |
|---|---|---|---|---|---|---|---|---|---|---|
| Evaluation | Resin | Presence of yield point | — | yes | yes | yes | yes | yes | yes | yes |
| result | mixture | Tensile yield stress | MPa | 30 | 38 | 39 | 30 | 53 | 46 | 37 |
| | (a1) | Nominal tensile | % | 62.3 | 6.9 | 14.0 | 62.3 | 23.4 | 42.8 | 42.8 |
| | | fracture strain | | | | | | | | |
| | | Izod impact strength | KJ/m² | 14.3 | 5.9 | 8.4 | 14.3 | 6.1 | 10.9 | 73.6 |
| | | (with notch) | | | | | | | | |
| | | Solid viscoelasticity | — | 0.0232 | 0.0206 | 0.0229 | 0.0232 | 0.0336 | 0.0335 | 0.0490 |
| | | tanδ (average 25-35° C.) | | | | | | | | |
| | Resin | Nominal tensile | % | 3.4 | 2.6 | 2.6 | 2.7 | 2.8 | 3.0 | 3.5 |
| | molding | fracture strain | | | | | | | | |
| | material | Izod impact strength | KJ/m² | 16.3 | 14.5 | 14.8 | 17.2 | 11.0 | 12.0 | 17.0 |
| | | (with notch) | | | | | | | | |
| | | Bending elastic | GPa | 3.8 | 4.9 | 5.1 | 4.3 | 4.4 | 4.0 | 4.0 |
| | | modulus (TD) | | | | | | | | |
| | | Relative dielectric | — | 2.89 | 2.71 | 2.73 | 2.85 | 3.35 | 3.32 | 3.24 |
| | | constant (10 GHz) | | | | | | | | |
| | | Dissipation factor | — | 0.0034 | 0.0020 | 0.0019 | 0.0026 | 0.0076 | 0.0072 | 0.0064 |
| | | (10 GHz) | | | | | | | | |
| | Resin | Tensile bonding | MPa | 22 | 30 | 26 | 22 | 40 | 35 | 30 |
| | metal | strength | | | | | | | | |
| | composite | Drop impact | — | A | A | A | A | A | A | A |
| | body | (six-side impact) | | | | | | | | |

TABLE 3

| | | | | | Example | | | | | | |
|---|---|---|---|---|---|---|---|---|---|---|---|
| | | | | | 14 | 15 | 16 | 17 | 18 | 19 | 20 |
| Resin | Resin | Resin | 90ZC | % by | 73.0 | | | | | | |
| molding | mixture | (1): | | mass | | | | | | | |
| material | (a1) | SPS | 60ZC | % by | | 78.0 | 73.0 | | | | |
| | | | | mass | | | | | | | |
| | | | 30ZC | % by | | | | 78.0 | 73.0 | | |
| | | | | mass | | | | | | | |
| | | Resin (2): | 1401 X06 | % by | | | | | | 90.0 | 90.0 |
| | | Polyester | | mass | | | | | | | |
| | | Rubber- | (1) Septon | % by | 20.0 | 15.0 | 20.0 | 15.0 | 20.0 | | |
| | | like | 8006 | mass | | | | | | | |
| | | elastomer | (2) H1041 | % by | 5.0 | 5.0 | 5.0 | 5.0 | 5.0 | | |
| | | (B) | | mass | | | | | | | |
| | | | (3) Bondfast | % by | | | | | | 10.0 | 10.0 |
| | | | E | mass | | | | | | | |
| | | Acid-modified polyphenylene ether (C) | | % by | 2.0 | 2.0 | 2.0 | 2.0 | 2.0 | | |
| | | | | mass | | | | | | | |
| | | Nucleating | NA-11 | part by | 0.5 | 0.5 | 0.5 | 0.5 | 0.5 | | |
| | | agent | | mass | | | | | | | |
| | | Antioxidant | Irganox 1010 | part by | 0.3 | 0.3 | 0.3 | 0.3 | 0.3 | | |
| | | | | mass | | | | | | | |
| | Resin mixture (a1)/inorganic filler (a2) (ratio in % by mass) | | | — | 70/30 | 70/30 | 70/30 | 70/30 | 70/30 | 80/20 | 60/40 |
| | Inorganic | Glass | (1) ECS03T- | % by | | | | | | | |
| | filler | filler | 249H | mass | | | | | | | |
| | (a2) | | (2) CSG3PA- | % by | 30 | 30 | 30 | 30 | 30 | | |
| | | | 820 | mass | | | | | | | |
| | | | (3) ECS03T- | % by | | | | | | 20 | 40 |
| | | | 187H | mass | | | | | | | |

| | | | | | | | | | | |
|---|---|---|---|---|---|---|---|---|---|---|
| Evaluation | Resin | Presence of yield point | — | yes | yes | yes | yes | yes | yes | yes |
| result | mixture | Tensile yield stress | MPa | 29.2 | 39 | 30 | 39 | 30 | 46 | 46 |
| | (a1) | Nominal tensile | % | 38.2 | 14.8 | 41.2 | 29.8 | 44.3 | 42.8 | 42.8 |
| | | fracture strain | | | | | | | | |
| | | Izod impact strength | KJ/m² | 10.8 | 9.9 | 19.2 | 52.0 | 75.2 | 10.9 | 10.9 |
| | | (with notch) | | | | | | | | |
| | | Solid viscoelasticity | — | 0.0232 | 0.0229 | 0.0232 | 0.0229 | 0.0232 | 0.0335 | 0.0335 |
| | | tanδ (average 25-35° C.) | | | | | | | | |
| | Resin | Nominal tensile | % | 2.6 | 2.6 | 2.6 | 2.6 | 2.6 | 3.2 | 2.8 |
| | molding | fracture strain | | | | | | | | |
| | material | Izod impact strength | KJ/m² | 15.9 | 14.8 | 16.2 | 14.8 | 16.2 | 12.0 | 14.9 |
| | | (with notch) | | | | | | | | |
| | | Bending elastic | GPa | 4.7 | 5.1 | 4.3 | 5.1 | 4.3 | 3.0 | 5.7 |
| | | modulus (TD) | | | | | | | | |
| | | Relative dielectric | — | 2.79 | 2.74 | 2.84 | 2.72 | 2.83 | 3.12 | 3.52 |
| | | constant (10 GHz) | | | | | | | | |
| | | Dissipation factor | — | 0.0023 | 0.0020 | 0.0024 | 0.0019 | 0.0022 | 0.0064 | 0.0084 |
| | | (10 GHz) | | | | | | | | |
| | Resin | Tensile bonding | MPa | 24 | 27 | 24 | 27 | 24 | 33 | 37 |
| | metal | strength | | | | | | | | |
| | composite | Drop impact | — | A | A | A | A | A | A | A |
| | body | (six-side impact) | | | | | | | | |

TABLE 4

| | | | | | Example | | | | | |
|---|---|---|---|---|---|---|---|---|---|---|
| | | | | | 21 | 22 | 23 | 24 | 25 | 26 |
| Resin | Resin | Resin (1)/ | 90ZC | % by | | | | | | |
| molding | mixture | SPS | | mass | | | | | | |
| material | (a1) | Resin (2)/ | 1401 X06 | % by | 90.0 | 90.0 | 90.0 | 90.0 | 90.0 | 90.0 |
| | | Polyester | | mass | | | | | | |
| | | Rubber- | (1) Septon | % by | | | | | | |
| | | like | 8006 | mass | | | | | | |
| | | elastomer | (2) H1041 | % by | | | | | | |
| | | (B) | | mass | | | | | | |
| | | | (3) Bondfast | % by | 10.0 | 10.0 | 10.0 | 10.0 | 10.0 | 10.0 |
| | | | E | mass | | | | | | |
| | | Acid-modified polyphenylene ether (C) | | % by | | | | | | |
| | | | | mass | | | | | | |
| | | Nucleating | NA-11 | part by | | | | | | |
| | | agent | | mass | | | | | | |
| | | Antioxidant | Irganox 1010 | part by | | | | | | |
| | | | | mass | | | | | | |
| | Resin mixture (a1)/inorganic filler (a2) (ratio in % by mass) | | | — | 80/20 | 70/30 | 60/40 | 80/20 | 70/30 | 60/40 |
| | Inorganic | Glass | (1) ECS03T- | % by | | | | | | |
| | filler | filler | 249H | mass | | | | | | |
| | (a2) | | (2) CSG3PA- | % by | | | | | | |
| | | | 820 | mass | | | | | | |
| | | | (3) ECS03T- | % by | | | | | | |
| | | | 187H | mass | | | | | | |
| | | | (4) CSG3AP- | | 20 | 30 | 40 | | | |
| | | | 830 | | | | | | | |
| | | | (5) CS(HL)303N-3 | | | | | 20 | 30 | 40 |

| | | | | | | | | | |
|---|---|---|---|---|---|---|---|---|---|
| Evaluation | Resin | Presence of yield point | — | yes | yes | yes | yes | yes | yes |
| result | mixture | Tensile yield stress | MPa | 46 | 46 | 46 | 46 | 46 | 46 |
| | (a1) | Nominal tensile | % | 42.8 | 42.8 | 42.8 | 42.8 | 42.8 | 42.8 |
| | | fracture strain | | | | | | | |
| | | Izod impact strength | KJ/m² | 10.9 | 10.9 | 10.9 | 10.9 | 10.9 | 10.9 |
| | | (with notch) | | | | | | | |
| | | Solid viscoelasticity | — | 0.0335 | 0.0335 | 0.0335 | 0.0335 | 0.0335 | 0.0335 |
| | | tanδ (average 25-35° C.) | | | | | | | |
| | Resin | Nominal tensile | % | 2.9 | 2.8 | 2.7 | 3.8 | 3.6 | 2.9 |
| | molding | fracture strain | | | | | | | |
| | material | Izod impact strength | KJ/m² | 13.9 | 16.4 | 17.2 | 15.6 | 16.1 | 15.9 |
| | | (with notch) | | | | | | | |
| | | Bending elastic | GPa | 3.8 | 5.2 | 6.9 | 2.9 | 4.1 | 5.4 |
| | | modulus (TD) | | | | | | | |
| | | Relative dielectric | — | 3.10 | 3.35 | 3.53 | 2.96 | 3.05 | 3.48 |
| | | constant (10 GHz) | | | | | | | |
| | | Dissipation factor | — | 0.0059 | 0.0068 | 0.0081 | 0.0061 | 0.0071 | 0.0083 |
| | | (10 GHz) | | | | | | | |
| | Resin | Tensile bonding | MPa | 34 | 36 | 38 | 32 | 34 | 37 |
| | metal | strength | | | | | | | |
| | composite | Drop impact | — | A | A | A | A | A | A |
| | body | (six-side impact) | | | | | | | |

TABLE 5

| | | | | | Comparative Example | | |
|---|---|---|---|---|---|---|---|
| | | | | | 1 | 2 | 3 |
| Resin | Resin | Resin (1): | 90ZC | % by | 88.0 | 58.0 | 0.0 |
| molding | mixture | SPS | | mass | | | |
| material | (a1) | Resin (2): | 1401 X06 | % by | | | 100.0 |
| | | Polyester | | mass | | | |
| | | Rubber- | (1) Septon | % by | 10.0 | 40.0 | 0.0 |
| | | like | 8006 | mass | | | |
| | | elastomer | (2) H1041 | % by | | | 0.0 |
| | | | | mass | | | |
| | | (B) | (3) Bondfast | % by | | | 0.0 |
| | | | E | mass | | | |
| | | Acid-modified polyphenylene ether (C) | | % by | 2.0 | 2.0 | 0.0 |
| | | | | mass | | | |
| | | Nucleating | NA-11 | part by | 0.5 | 0.5 | |
| | | agent | | mass | | | |
| | | Antioxidant | Irganox 1010 | part by | 0.3 | 0.3 | |
| | | | | mass | | | |
| | Resin mixture (a1)/inorganic filler (a2) (ratio in % by mass) | | | — | 70/30 | 70/30 | 70/30 |
| | Inorganic | Glass | (1) ECS03T- | % by | 30 | 30 | |
| | filler | filler | 249H | mass | | | |
| | (a2) | | (2) CSG3PA- | % by | | | |
| | | | 820 | mass | | | |
| | | | (3) ECS03T- | % by | | | 30 |
| | | | 187H | mass | | | |

| | | | | | | |
|---|---|---|---|---|---|---|
| Evaluation | Resin | Presence of yield point | — | no | yes | no |
| result | mixture | Tensile yield stress | MPa | — | 23 | — |
| | (a1) | Nominal tensile | % | 2.4 | 62.6 | 15.9 |
| | | fracture strain | | | | |
| | | Izod impact strength | KJ/m² | 3.0 | 22.0 | 4.4 |
| | | (with notch) | | | | |
| | | Solid viscoelasticity | — | 0.0196 | 0.0258 | 0.0303 |
| | | tanδ (average 25-35° C.) | | | | |
| | Resin | Nominal tensile | % | 2.5 | 3.5 | 2.5 |
| | molding | fracture strain | | | | |
| | material | Izod impact strength | KJ/m² | 10.8 | 16.8 | 10.0 |
| | | (with notch) | | | | |
| | | Bending elastic | GPa | 4.5 | 3.6 | 4.8 |
| | | modulus (TD) | | | | |
| | | Relative dielectric | — | 2.98 | 2.87 | 3.38 |
| | | constant (10 GHz) | | | | |
| | | Dissipation factor | — | 0.0031 | 0.0035 | 0.0080 |
| | | (10 GHz) | | | | |
| | Resin | Tensile bonding | MPa | 30 | 16 | 45 |
| | metal | strength | | | | |
| | composite | Drop impact | — | B | B | B |
| | body | (six-side impact) | | | | |

### INDUSTRIAL APPLICABILITY

According to the present invention, a resin metal composite body that has a bonding portion that is hard to undergo fracture, e.g., cleavage and exfoliation, on uneven application of a stress to one side or an edge of the bonding surface, and is capable of being used in the high frequency band, and a method for producing the same can be provided.

### REFERENCE SIGNS LIST

11: Metal member
12: Resin member
13: Skin layer
14: Core layer
15: Inorganic filler
16: Rubber-like elastomer
21: Metal member
22: Resin member
1: Metal member
2: Resin member
3: Resin member
4: Glass

1. A resin metal composite body comprising a resin member containing a resin molding material containing a resin mixture (a1) and an inorganic filler (a2), and a metal member,
a test specimen of the resin mixture (a1) having a stress-strain curve in a tensile test according to ISO 527-1,2:2012 having a yield point, and a tensile yield stress of 25 MPa or more.

2. The resin metal composite body according to claim 1, wherein the test specimen of the resin mixture (a1) has a nominal tensile fracture strain of 2.5% or more in a tensile test according to ISO 527-1,2:2012.

3. The resin metal composite body according to claim 1, wherein a test specimen of 20 mm×5 mm×0.8 mm in thickness of the resin mixture (a1) has a loss tangent (tan δ) of solid viscoelasticity of 0.0200 or more measured under condition of a frequency of 1 Hz and around room temperature according to ISO 6721-4:1994.

4. The resin metal composite body according to claim 1, wherein the resin mixture (a1) contains at least one kind selected from a syndiotactic polystyrene, a polyester, a polyphenylene sulfide, a polyamide, and a polyether ether ketone.

5. The resin metal composite body according to claim 1, wherein the resin molding material contains the inorganic filler (a2) in an amount of 13.0% by mass or more and 37.0% by mass or less based on the total of the resin mixture (a1) and the inorganic filler (a2) as 100% by mass.

6. The resin metal composite body according to claim 1, wherein the resin molding material contains a glass filler as the inorganic filler (a2).

7. The resin metal composite body according to claim 1, wherein the resin metal composite body is an insert molded body.

8. The resin metal composite body according to claim 1, wherein the metal member is at least one kind selected from the group consisting of aluminum, stainless steel, copper, titanium, and alloys thereof.

9. The resin metal composite body according to claim 8, wherein the metal member is aluminum or an aluminum alloy.

10. The resin metal composite body according to claim 1, wherein the metal member has a surface subjected to at least one selected from a chemical treatment and a physical treatment.

11. The resin metal composite body according to claim 1, wherein the resin metal composite body has pores having a diameter of 0.01 μm or more and 1,000 μm or less in at least a part of a surface of the metal member that is in contact with the resin member.

12. A method for producing the resin metal composite body according to claim 1, comprising injection molding the resin molding material on the metal member.

13. The method for producing the resin metal composite body according to claim 12, wherein the method further comprises subjecting the resin metal composite body obtained after injection molding, to cutting work using a working fluid.

14. A method for producing a resin metal composite body, comprising subjecting the resin metal composite body according to claim 1, to an anodization treatment and a pore sealing treatment.
